(19) United States
(12) Patent Application Publication
(10) Pub. No.: US 2003/0076487 A1
(43) Pub. Date: Apr. 24, 2003

(54) System and method for glass processing and stress measurement

(76) Inventors: Bret D. Cannon, Richland, WA (US); Chester L. Shepard, West Richland, WA (US); Mohammad A. Khaleel, Richland, WA (US)

Correspondence Address: John M. Bradshaw, Woodard, Emhardt, Naughton, Moriarty and McNett, Bank One Center/Tower, 111 Monument Circle, Suite 3700, Indianapolis, IN, 46204-5137, US

(21) Appl. No.: 09/921,609

(22) Filed: Aug. 3, 2001

(51) Int. Cl. G01B 11/16

(52) U.S. Cl. 356/33

(57) ABSTRACT

A non-destructive and non-contact method for measuring stress at the mid-plane of tempered glass plates that uses Bragg scattering from a pair of thermal gratings. The gratings are formed by parallel writing beams of laser light retroreflected through the glass. The polarization state of light from a delayed laser beam that scatters from both these thermal gratings is measured, and the change in polarization of the doubly scattered light with separation between the two gratings is correlated to the in-plane stress. Systems and techniques to take these measurements and control a glass manufacturing process are also disclosed.

### RELATED APPLICATION DATA

This application is related to application Ser. No. 09/870,332, filed May 30, 2001 titled System and Method for Glass Processing and Temperature Sensing and naming the same inventors as the present application.

This invention was made with Government support under Contract Number DE-AC0676RLO1830 awarded by the U.S. Department of Energy. The Government has certain rights in the invention.

### FIELD OF THE INVENTION

The present invention is related to the manufacture and quality assessment of transparent materials. More particularly, but not exclusively, it is related to the determination of stress in glass products.

### BACKGROUND OF THE INVENTION

Residual stresses are a major factor in determining the quality of glass products because these stresses determine the mechanical strength and failure mode of the glass products, such as, for example, automotive or architectural windows. Low internal stresses are usually desired to facilitate fabrication of a glass object to a desired size and shape by cutting or grinding. By contrast, the compressive surface stresses created by tempering a glass window can multiply its breaking strength by up to 6 times, which can substantially improve the durability of a window, for example, doubling the maximum velocity with which a stone can hit a window and have the window survive without damage. The balancing internal tensile stresses insure that upon breaking the resulting pieces will be small and safe rather than large sharp shards that can badly cut an accident victim. However, excessive stresses, even at a single point, can greatly weaken a window and even lead to spontaneous breakage. Thus, knowledge of the residual stresses is important for assuring the quality of glass products.

Tempered automotive glass is currently tested by using the 4-point break test on a sample of the production run and measuring the distribution of sizes of the resulting pieces. Other tests for tempered glass include dropping steel balls of a specified weight from a specified height onto the tempered glass window.

These current testing procedures are costly and unsatisfactory both because of the amount of substandard product produced before defective product is first detected and because the results do not provide much useful information that would help to identify the causes of the product defects. Once a tempered piece of glass is broken, all that is left is a pile of small pieces. Since glass manufacture is extremely energy intensive, there are substantial economic impacts if the volume of defective products produced exceeds very small amounts. Accordingly a technique for the rapid, non-destructive, and spatially resolved measurement of residual stress in glass could help improve the quality of the products and reduce costs of tempered glass production.

Stress is a tensor quantity that can be specified by giving the components along the three principal axes and the orientation of these axes relative to the object at each point in the object. At any surface, one of the principle axes is normal to the surface and that principal stress component is zero. For uniform tempering, the two principal stresses in the plane of the surface are degenerate and compressive, and the stress in the direction normal to the surface is zero through the thickness of the glass. In a tempered plate, the stress along a given direction in the plane of the surface is compressive on the surface, becomes tensile in the middle, and then compressive on the other surface. For uniformly tempered glass, this stress profile is symmetric about the mid-plane of the plate and the integral of this stress through the thickness of the plate is zero. For thin glass plates, this stress profile is parabolic and the magnitude of the compression on the surfaces is twice the magnitude of the tension at the mid-plane. Edges and any transverse spatial variations in the cooling rates break the degeneracy of the two in-plane principal stress axes and create deviations from this ideal stress pattern.

Current attempts to develop an effective and practical non-destructive technique for measuring surface stress include optical measurements based on the equation

(δnₐ−δn_{b})/n=B(Sₐ−S_{b})

where (a,b,c) is a Cartesian coordinate system and the light propagates along the c axis, (δnₐ−δn_{b})/n is the difference in the fractional change in the refractive index for the a and b components of the electric field of a light wave due to the difference between the a and b components of the stress, (Sₐ−S_{b}) and B is the stress optical coefficient (also referred to as the stress optic coefficient or stress birefringence coefficient). For light propagating in the plane of a tempered glass surface and the b axis normal to that plane, then S_{b} is zero and the birefringence (δnₐ−δn_{b})/n is proportional to Sₐ. That S_{b} is zero does not mean that δn_{b} is zero since a stress in a given direction changes the refractive index both parallel and perpendicular to the direction of stress. A typical compressive surface stress is 15,000 psi for tempered soda-lime float glass and B for soda-lime glass is 2.6×10⁻¹² Pascal⁻¹ or 1.8×10⁻⁸ psi⁻¹. Using these values, the birefringence would be 2.7×10⁻⁴ or 2.3 mm of travel for 1 wave of retardation at 633 nm.

The most common current optical stress measurement method is to measure the change in polarization state of light after it passes through the sample traveling normal to the surface. However, this method provides little useful information on the surface stresses. In such a case, the c-axis is normal to the surface and the birefringence is proportional to the difference in the principal stresses in the planes parallel to the surface. Very small differences in stresses can be measured this way but the effect is integrated over the full path through the glass and so is not sensitive to surface stress. For a tempered glass sheet, Sₐ and S_{b} are nearly the same except near the edges and the integrals of Sₐ and of S_{b} through the thickness of the glass are nearly zero. Thus, except for near an edge, this measurement gives no information about the surface stresses that strengthen or weaken the glass nor information about tensile stresses in the middle of the thickness that are responsible for breaking into small pieces. Theoretically, only a technique where light travels parallel to the surface could measure these stresses.

For float glass with a tinned surface, a grazing angle surface polarlimeter (Strainoptic Technologies, Inc.) represents one instrument potentially useful for measuring surface stress. However, this method requires high index prisms and index matching fluid to couple polarized light into and out of the wave-guide formed by the tin that diffused into the glass near the surface. Accordingly, this method is limited and labor intensive.

Another method, known as the Rayleigh fringe technique, utilizes the injection of polarized light through the edge of the sample or at a very shallow angle to the surface by use of index matching fluid or a coupling prism. The birefringence in the stressed glass is then observed by measuring the Rayleigh scattered light. The angular distribution of Rayleigh scattering from linearly polarized light is zero along the polarization axis and a maximum normal to that axis. Thus, fringes in the Rayleigh scattered light can be observed as light travels through a birefringent medium where the fringe period is the distance for one-wave of retardation. These fringes have the largest contrast and thus are easiest to detect and use when the observation direction and the axis of the initial linear polarization are both at 45° to the principal stress axes in the plane normal to the propagation direction. However, for tempered glass one of the principal axes is close to normal to the surface and so the light scattered at 45° degrees to this principal axis will be trapped by total internal reflection. Either index matching fluids or coupling prisms can be used or observation must be performed at a non ideal angle with resultant loss of signal.

Moreover, like other methods, difficulties exist in coupling the light into the glass so that it travels parallel to the surface at the point where the stress is to be measured. In addition, in order to produce useful data, the stress generally must be constant over the measured volume and the measured volume must have a length of at least one fringe period. Accordingly, the Rayleigh fringe technique is usually restricted to small pieces of flat glass with polished edges.

Therefore, there continues to be a need for an effective and practical technique for determining the residual stresses in glass. Accordingly, there is also a need for a technique that can provide localized stress measurements throughout a major portion of a glass sample. There is also a need for a technique that can provide stress measurements in a rapid and non-destructive manner. There is also a need for a system and method to utilize measured stress information to improve the efficiency of glass production and energy consumption.

### SUMMARY OF THE INVENTION

In one embodiment there is provided a new technique for measuring stress wherein thermal gratings are used to couple a probe beam of light into and out of a glass sample and stress is determined from the relative polarization change of the probe beam. The thermal gratings are volume gratings formed by induced periodic temperature variations formed by standing light waves. In one refinement, a probe beam is directed incident on the first thermal grating and is diffracted into a beam traveling parallel to the surface of the glass. This singly deflected beam probes the stress birefringence along its path and a second thermal grating diffracts a fraction of this beam to form a doubly deflected beam. This doubly deflected beam exits the glass sample and its polarization state is measured. The variation of the polarization state as a function of distance between the two thermal gratings is then used to determine the stress in the interior of the glass sample. In still a further preferred aspect, the thermal gratings can be formed by a pair of parallel beams split from a laser pulse that generates the probe beam, where the probe beam is then frequency doubled after stripping the thermal grating forming beams. In yet a further preferred aspect, the optical path length of the probe beam from its source to the glass sample is greater than that of the thermal grating beams such that incidence of the probe beam on the glass sample is delayed relative to the incidence of the thermal grating beams.

In other embodiments a system for evaluating characteristics of a transparent material is provided comprising an optical assembly for delivering a probe beam and a pair of writing beams to a surface of the material. The writing beams are retroreflected through the material to form first and second thermal gratings in the material, and the probe beam intersects the first thermal grating causing at least a portion thereof to travel substantially parallel to a surface of the material and intersect the second thermal grating to form a doubly deflected beam that exits the material. A detector assembly receives the doubly deflected beam and determines the polarization state of the doubly deflected beam. The optical assembly includes means for forming the second thermal grating at varying distances from the first thermal grating, and the detector assembly includes means for capturing the doubly deflected beam formed at the second thermal grating at varying distances from the first thermal grating. In certain refinements an alignment system is also provided for monitoring and maintaining the alignment of the probe and writing means so as to cause the singly deflected beam to be formed in the center of the material and traveling parallel to the surface.

It is an object of the present invention to provide an improved technique for monitoring material, especially transparent materials such as glass.

It is also an object to provide improved techniques for processing glass and eliminating or reducing the occurrence of defects or defective product.

These and other objects are met in various embodiments of the present invention.

### BRIEF DESCRIPTION OF THE DRAWINGS

FIG. 1 is a schematic view of a glass processing system according to an aspect of the present invention.

FIG. 1A is a schematic view of a stress analysis station of the FIG. 1 glass processing system.

FIG. 2 is a schematic illustration of a stress sensor interrogating a piece of glass according to an embodiment of the present invention.

FIG. 3 is a vector illustration of the wave vectors for light scattering from a pair of thermal gratings.

FIG. 4 is a schematic diagram of a detector in the FIG. 2 sensor.

FIG. 5 is an illustrative plot of the temperature distribution through the thickness of a piece of glass formed by a standing wave.

FIG. 6 is an illustrative plot of the time variation of the deflection efficiency plotted with the time variation of the probe pulse.

FIG. 7 is a plot of the measured dependence of the deflection efficiency with the power of the writing beams.

FIG. 8 is a plot of the profiles of a singly deflected beam as a function of depth from the mid-plane in annealed glass.

FIG. 9 is a plot of the profiles of a doubly deflected beam as a function of depth from the mid-plane in annealed glass.

FIG. 10 is a plot of signal strength versus depth in annealed glass for a singly deflected beam (hollow diamonds) and a doubly deflected beam (filled squares).

FIG. 11 is a plot of scattered green light and doubly deflected signal as a function of distance from the transmitted probe beam.

FIG. 12 is a plot of the measured stress in the middle of the calibration sample as a function of the applied nominal stress.

FIG. 13 is a plot of the measured stress at the center and ±0.5 mm from the center of the calibration glass sample.

FIG. 14 is a plot of the stresses measured with two different techniques for compressive stresses.

FIG. 15 is a plot of the in-plane stress measured at the center of the thickness of a tempered glass sample.

FIG. 16 is a schematic illustration of probe and writing beams intersecting in a glass sample.

FIG. 17 is a partial schematic illustration of an alignment monitoring system in use with the FIG. 2 sensor.

### DESCRIPTION OF EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the illustrated devices, and any further applications of the principles of the invention as illustrated herein are contemplated as would normally occur to one skilled in the art to which the invention relates.

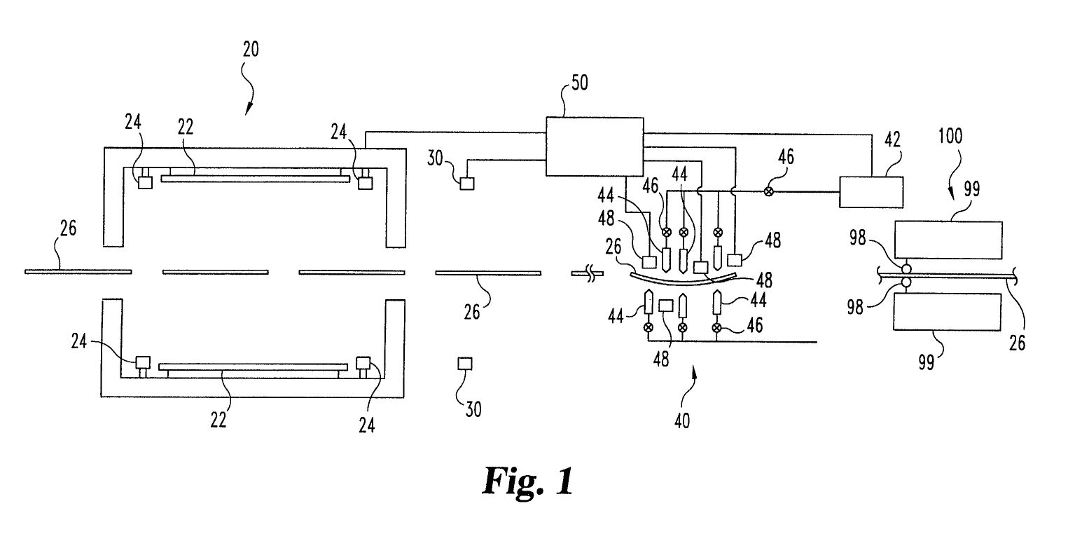

Turning now to FIG. 1 a glass processing system according to the present invention is illustrated. Glass sheets 26 are conveyed through furnace 20, which includes heating elements 22. The sheets can be conveyed in any conventional fashion, for example along rollers (not shown), on a bed of air, while floating on molten tin, or while suspended at their edges by tongs. Upon reaching the desired temperature the sheets are conveyed to quenching station 40. At the quenching station or elsewhere along the process, for example in the furnace or at an intermediate assembly, the glass sheets can be formed into any desired shape as is known in the art.

At the quenching station a plurality of nozzles 44 are configured to direct a cooling fluid onto one or more sides of sheet 26 to rapidly cool sheet 26. The exposed surfaces of sheet 26 are cooled by fluid from nozzles 44 causing temperature gradients to form through the thickness of the sheet 26. As the glass hardens the temperature gradients cause internal and surface stresses to form in the glass. The magnitude and location of the temperature gradients determine, in large part, the magnitude and location of the stresses that are locked into the glass.

Quenching controller 42 directs the supply of the cooling fluid, which can be pressurized air or any other known cooling fluid such as an air water mixture, and operates valves 46 to control the flow of fluid through nozzles 44. Controller 42 can operate nozzles and valves 46 to vary the quenching pattern according to a predetermined formula, varying quenching variable such as flow rate, fluid temperature, nozzle angle, and nozzle distance from glass. In addition, controller 42 can receive a set point adjustment or other signal from controller 50 to adjust one or more of the quenching variables.

A plurality of temperature sensors 30, 24, 48 are located throughout the glass processing system including at quenching station 40 and are electrically connected to controller 50 to provide sensor output signals. As described more fully in related application titled System and Method for Glass Processing and Temperature Sensing and filed May 30, 2001, Ser. No. ______ naming the same inventors as the present application, one or more of sensors 24, 30, 48, in conjunction with a processor, can be configured to determine the temperature profile of the glass and provides an output signal to controller 50. Controller 50 utilizes the sensor output signals of sensors 30, 24, 48 to control the glass processing system. For example controller 50 might adjust a heating variable or a quenching variable to bring the temperature profile into accordance with a desired temperature profile so as to produce glass of a desired quality or stress pattern. Alternatively any conventional control system and temperature sensors can be used. Controllers 50 and 42 may each include processing units, data storage, input and output ports, and other features incorporated into conventional system control modules. One or both of the controllers may receive sensor output signals of either digital or analog. While the preferred embodiment shown in FIG. 1 illustrates separate controllers 50 and 42, it is contemplated that all the components, features and functions may be housed in a central controller or, conversely, the signal processing and control functions may be more widely dispersed without deviating from the present invention.

After quenching, one or more of the glass sheets 26 from a production run are sent to a stress analysis station 100. Preferably station 100 is a part of the production line such that all processed glass passes through station 100. However it is contemplated that station 100 can be used on isolated sheets 26 for quality control purposes. Still further, a first station 100 may be used in the production line to provide coarse quality control based on limited sample areas while a second station 100 may be located off the production line to provide detailed feedback on the quality of the glass product.

At station 100, a pair of supports 98 align glass sheet 26 with sensor 99. Under computer control, sensor 99 interrogates glass 26 and determines stress information about the glass. Movement of upper and lower portions 99a and 99b of sensor 99 relative to sheet 26 permits interrogation of locations in the glass throughout the sheet 26. The stress information can include the magnitude and/or relative distribution of stresses in the glass. The stress information can be used to determine the quality of the glass by comparing the determined stress information with a predetermined desired stress or stress distribution. For example a maximum and/or minimum range of desired stress can be set with acceptable glass product having stresses within the preset limits.

Output corresponding to the determined stress can also be sent to controller 50. Controller 50 can adjust one or more operating parameters in response to the determined stress falling outside predetermined limits or equivalently signal a human operator to make the required change. In one embodiment, the measured stress is used to validate and optimize the control settings to produce glass of a predetermined desired stress pattern. Further, the measured stress may provide an indication of maintenance problems with the heating elements 22 or quenching nozzles 44.

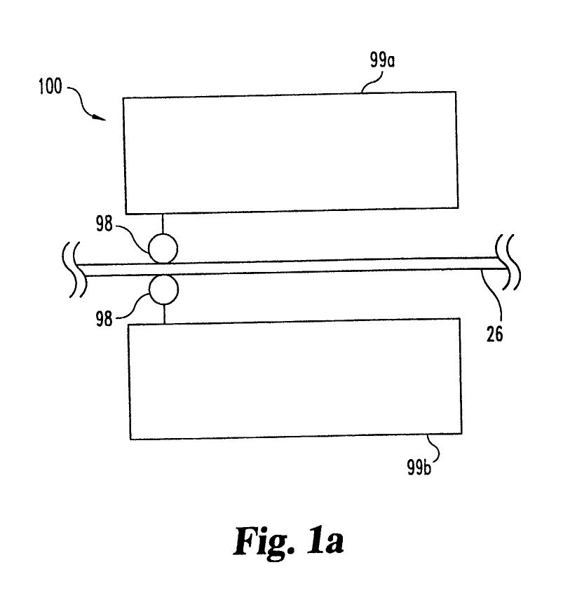

FIG. 2 is a schematic diagram of sensor 99 in use to obtain stress information from glass sheet 26. Writing beam 110 is used to create two thermal gratings 102 and 104. Beam splitter 130 and mirror 132, mounted on a translation stage (not shown), split writing beam 110 into a pair of parallel beams 140 and 150. After passing through glass sample 26, writing beams 140 and 150 are retro-reflected by mirror 134 to form a pair of standing waves. The standing waves form localized thermal variations in the glass.

Probe beam 120 is generated in the same plane as writing beams 140 and 150. Probe beam 120 is focused at and deflected by first thermal grating 104. Singly deflected beam 160 originates at the intersection of probe beam 120 with first thermal grating 104 and travels parallel to the glass surfaces. Before exiting glass 26, singly deflected beam 160 encounters second thermal grating 102 and is deflected. Doubly deflected beam 170 originates at the intersection of singly deflected beam 160 and second thermal grating 102 and exits glass 26. Doubly deflected beam 170 is picked off by mirror 145, mounted on a translation stage (not shown), and sent to Stokes meter 180 or another type of detector. The polarization shift of doubly deflected beam 170 attributable to its travel between gratings 102 and 104 is used to determine the stresses in glass 26.

Laser 101 is a commercial injection seeded pulsed Nd:YAG (Continuum Model YG661) producing light at 1064 nm (near infrared NIR) and 532 nm (green). Laser 101 has a 10 Hz repetition rate and is used as a single source for beams 120, 140, and 150. The commercial laser 101 is modified by inserting a small aperture in the oscillator cavity and inserting an absorptive glass filter in the beam between the oscillator and the amplifier to prevent saturation in the amplifier rod from degrading the transverse mode quality.

It was found that after the doubling crystal 122, the beam quality of the fundamental beam (the remaining light at 1064 nm) is severely degraded. Such an aberrated beam may form a thermal grating with distorted phase fronts and amplitudes and consequently poor diffraction efficiency. To avoid this loss, a 50% beam splitter 103 splits the 1064 nm TEM₀₀ beam from the laser 101 prior to the doubling crystal 122. Beam 120 is then frequency doubled with crystal 122 to provide the probe beam 120 at twice the frequency of the writing beam 110.

A Faraday isolator 104 protects the laser 101 from the retro-reflected writing beams 140 and 150. A half-wave plate 106 rotates the writing beam 110 polarization to horizontal (in the plane of the page), and then the writing beam 110 passes through a Galilean telescope 108 that forms a 0.35 mm radius waist at the glass sample. As discussed above, a second beam splitter 130 and mirror 132 mounted on a translation stage splits the writing beam 110 into a pair of parallel beams 140 and 150 and the writing beams 140 and 150 are retro-reflected by mirror 134 to form standing waves. The separation between beams 140 and 150 is changed by translation of mirror 132, and the pulse energies in the two writing beams 140 and 150 incident on the glass 26 are approximately 6 ml and 9 mJ. The pulse length (full width at half height) is 7 ns.

The 532 nm probe beam 120 is generated in the doubling crystal 122 after the 50% beam splitter 103 and separated from the residual fundamental light by passing through a filter (not shown). Probe beam 120 is directed with mirrors 124 and 126 and focused at the first thermal grating with a 750 mm focal length lens 128. Between the final turning mirror 126 and the glass sample 26, the probe beam passes through a Berek's polarization compensator 129 (New Focus Model 5540) to adjust the polarization to linearly polarized at 45° from vertical. The optical path length of probe beam 120 is preferably at least about 2 feet longer in air than that of writing beams 140 and 150 to provide an approximately 2 ns delay. Typically 3 mJ per pulse of probe beam energy is incident on the glass 26 in a beam of 0.20 mm diameter. The laser fires every 100 msec.

An absorptive neutral density filter 178 with a transmission of 10⁻⁴ is placed on the detector side of glass 26 to absorb most of the transmitted probe beam 120 and the first three of the set of parallel beams generated by Fresnel reflections from the back and then front surfaces of the glass sample.

As discussed above, singly deflected beam 160 originates at the intersection of probe beam 120 with first thermal grating 104. Preferably, beam 160 travels substantially parallel to the glass surface during its travel between gratings 102 and 104. For studies of the singly deflected beam 160 reported herein, flat samples were used that had polished edges such that beam 160 could be observed outside the glass sample at various depths from a surface of the glass.

Also as discussed above, doubly deflected beam 170 originates at the intersection of singly deflected beam 160 and second thermal grating 102. When writing beams 140 and 150 are parallel and of the same wavelength, doubly deflected beam 170 travels parallel to the original probe beam 120. The origin of doubly deflected beam 170 within glass 26 changes with changes in the separation between thermal gratings 102 and 104. Mirror 145 is mounted on a motorized translation stage (not shown) and picks off doubly deflected beam 170 and sends it to Stokes meter 180. Translation of pick off mirror 145 compensates for this variation and allows doubly deflected beam 145 to always enter the relatively fixed Stokes meter 180 along the same optic axis.

To probe various locations in the glass, the glass can be mounted in a fixture (not shown) that allows three orthogonal translations; two in the plane of glass 26 and one along the surface normal of the sample. The range of in plane motion can be large enough that any point in the glass can be moved into the beam paths. Dial indicators can measure the translation of the sample in each direction. For example, measurement of translation along the surface normal allows measurement of the relative position from the surface of the intersection of probe beam 120 and first thermal grating 104. To facilitate alignment of the optics with the glass, the fixture also allows for rotations of the sample about a vertical axis and a horizontal axis in the plane of the sample that both pass through the first thermal grating.

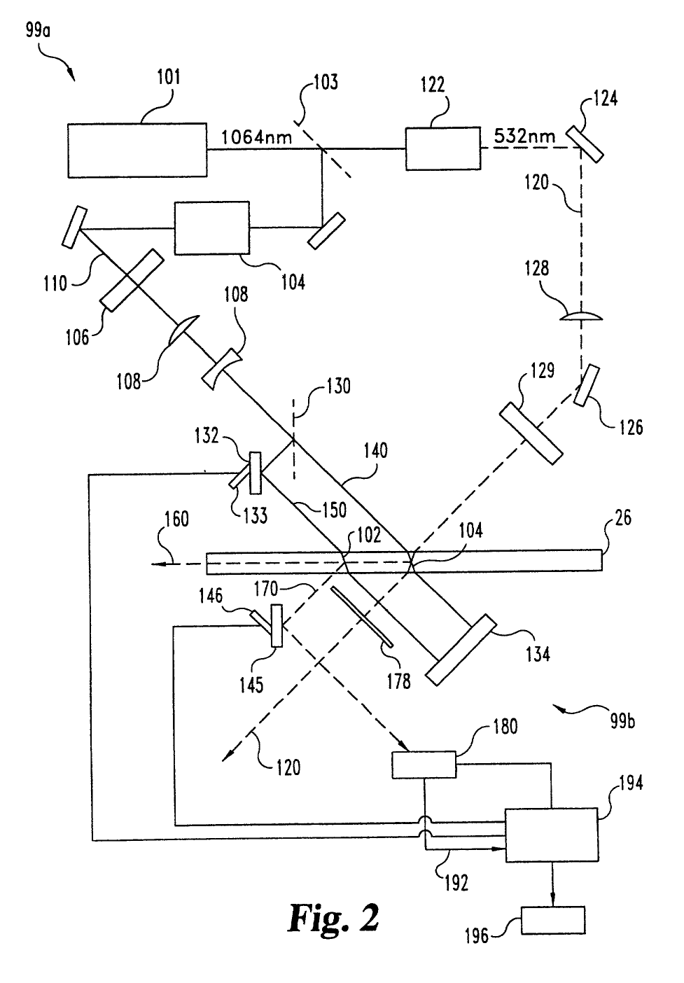

FIG. 3 shows the vector representation of the Bragg condition for the scattering from the two thermal gratings, k_{scattered}=k_{incident}+k_{grating} where the three terms are the wave vectors of respectively the scattered light beam, the incident light beam, and the thermal grating. In each of the plots, k refers to the grating wave vectors, k_{d1} and k_{d2} refer to the singly and doubly deflected beams, and k_{probe} refers to the probe beam. In the illustrated embodiment, the wave vectors of the incident and scattered light have magnitudes of 2πn₅₃₂/532 nm and their directions are the direction of propagation. The period of the thermal grating is 1064 nm/2n_{NIR} so the wave vector has a magnitude of 4πn_{NIR}/1064 nm and a direction of either orientation along the thermal grating, which corresponds to the +1 and −1 orders of diffraction. In the expression for the magnitudes, n₅₃₂ and n_{NIR} are the refractive indices of the glass at the 532 nm and 1064 nm respectively. Except for the small change in refractive index between the two wavelengths, all three wave vectors have equal magnitudes and they form an equilateral triangle. To make the singly deflected beam travel parallel to the surface, the probe beam and thermal grating are at −30° and +30° from the surface normal respectively. Assuming a refractive index in the glass of 1.5, in the air the 1064 nm and 532 nm beams are at −50° and +50° from the surface normal respectively. For the actual refractive indices of n_{NIR} equal to 1.507 and n₅₃₂ equal to 1.524, the actual exterior angles are +49.6° for the NIR beam and −48.1° for the green beam.

The apparatus is originally aligned starting with the two beams 140 and 150 parallel and in the same horizontal plane. Beam 150 is then blocked and telescope 108 and the fixture are adjusted to place the waist of beam 140 on the first surface of glass 26 at a point on the vertical rotation axis (into the plane of the figure) of the fixture. Glass 26 is initially aligned to have the top major surface normal to the incident beam 140, and then the glass is rotated about the vertical axis by (49.6°+48.1°)/2 so that the reflection of beam 140 from the first surface of the sample traces the probe beam path in the reverse direction. Probe beam 120 is then aligned along this reflected beam and lens 128 adjusted to place the waist of the beam 120 at the sample.

The glass plate can now be rotated back 0.75° to have beam 140 incident at 49.6°. The retro-reflecting mirror 134 is adjusted to retro-reflect beam 140, and the glass is moved about ¼^{th} its thickness towards the incident beams. This last action places the intersection of probe beam 120 and first thermal grating 104 near the middle of the glass plate, since the change in the position of this intersection relative to the surface of the plate is 2.05 times the distance the plate is moved.

Fine adjustments of the angle of probe beam 120 in the horizontal plane are then made to find singly deflected beam 160. Adjustments of the vertical and horizontal probe beam angles, the position of lens 128 and the focus of telescope 108 are used to optimize the strength of singly deflected beam 160. Once singly deflected beam 160 is optimized, the beam 150 is unblocked to form second thermal grating 102 and generate doubly deflected beam 170.

Doubly deflected beam 170 is most easily found after completely realigning the apparatus by translating probe beam 120 until it intersects second thermal grating 102 in the middle of the glass 26 to find the path that the doubly deflected beam will take. Translating probe beam 120 is accomplished by translating mirror 126 towards lens 128, maintaining the angle of probe beam 120 relative to thermal gratings 102 and 104. The transmitted probe beam, after suitable attenuation, is then aligned into detector 180. Probe beam 120 is then translated back to its original position so that it again intersects first thermal grating 104.

The polarization of probe beam 120 just before polarization compensator 129 is elliptical due to the reflections from the dielectric mirrors 124, 126. To make the polarization of beam 120 incident on the sample linear and at an angle of 45° from vertical, the angle and retardation of polarization compensator 129 are adjusted to minimize the first surface reflection from the glass sample, which gives linear, horizontally polarized light. A polarizer is then temporarily inserted into the probe beam and rotated to minimize transmission. Then this temporarily inserted polarizer is rotated by 45° and polarization compensator 129 is re-adjusted to give minimum signal, which gives the desired linear polarization.

A comparison of the path taken by light that exits the glass in the probe beam with that taken by the doubly deflected beam in FIG. 2 shows that there are three elements that could change the polarization between these two beams. The first element is the two deflections by the thermal gratings, the second is birefringence along the path between the two thermal gratings, and the last is the difference in the birefringence in the two paths between the thermal gratings and the exit surface of the glass. In the case of uniform tempering the last element would not cause any difference in polarization and ideally a pair of constant Meuller or Jones matrices should represent the effects of the thermal gratings. Thus, a single polarization measurement for the probe and doubly deflected beams could suffice to determine the stress to within an integer number of waves of retardation.

An alternative technique to measure the stress is to measure the polarization state of the doubly deflected beam at several different separations between the thermal gratings. The stress can then be calculated by looking at the changes in polarization with separation. Once the degrees of retardation per length of travel between the thermal gratings is determined, the birefringence can be calculated by multiplying the conversion factor of the probe beam wavelength in a vacuum divided by 360, recognizing that one wavelength of retardation gives a 360 degree rotation. Dividing the birefringence by the stress optic coefficient yields the relevant stress value in the material. This is the differential double thermal grating stress measurement technique presented below.

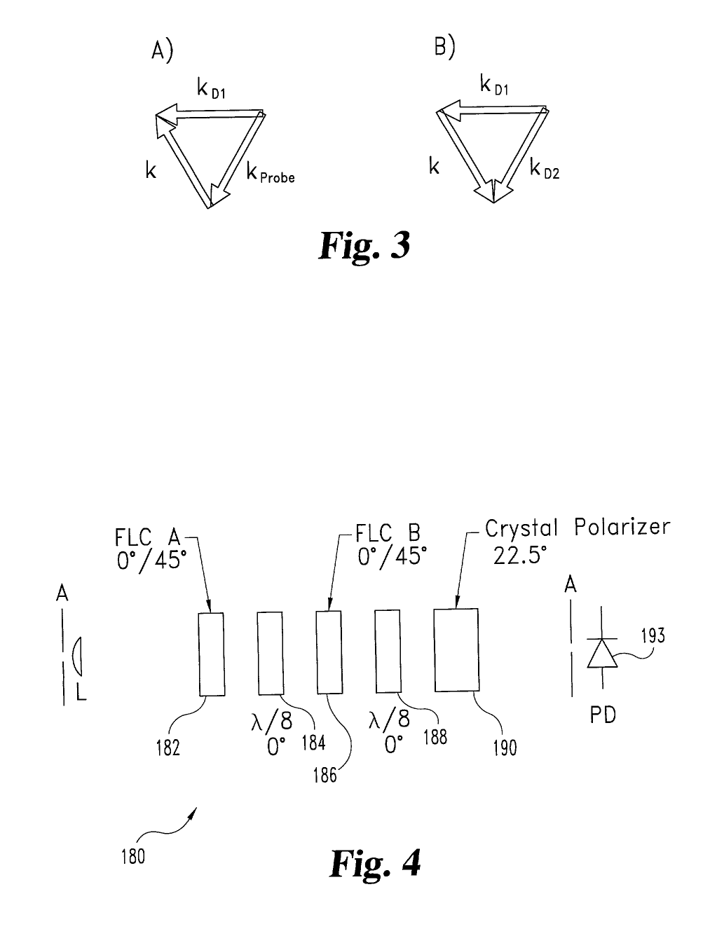

FIG. 4 is a schematic diagram of a Stokes meter type detector 180 that uses ferroelectric liquid crystal (FLC) waveplates 182, 186 (Display Tech Model LV1300-OEM), a pair of λ/8 waveplates 184, 188 (Karl Lambrecht Model MWPQC8-12-V532), a crystal polarizer 190, and a photodiode 193 (Hamamatsu Model S1223). For each laser pulse, the photocurrent from the photodiode is integrated by a charge sensitive preamp (EG&G Ortec Model 142A), amplified (EG&G Ortec Model 575A), and digitized to 12 bits by a card (National Instruments Model PCI 6111E) in the data collection computer 194.

The FLC waveplates 182 and 186 are λ/2 waveplates that can switch the orientation of their fast axes from 0° to 45° in less than a millisecond. With each FLC having two possible states, there are four possible states for this optical setup. From the measured signal corresponding to each state, all four Stokes parameters of the signal beam can be calculated as linear combinations of these four measurements. The four Stokes parameters (I, Q, U, V) fully characterize the polarization state of a light beam and the phase shift, δ, between the horizontal and vertical components of the electric field is given by tan(δ)=V/U and which quadrant δ lies in is determined by the signs of U and V.

Since FLCs 182 and 186 can switch states much faster than the 100 ms between laser pulses, it is possible to make a complete measurement every four laser pulses or every 0.4 second. The computer changes the FLC states with every pulse to obtain a complete set of data every four pulses. Equivalent data from approximately 30 cycles are averaged before calculating Stokes parameters. In certain applications, a complete polarization characterization may not be necessary.

Computer 194 is electrically connected 192 to detector 180 to receive outputs and control the states of the two FLC waveplates 182 and 186. Computer 194 also controls motorized translation stages 133 and 146 that move mirrors 132 and 145 respectively (see FIG. 2) and provides an output 196. In a preferred aspect, this same computer 194 also calculates the Stokes vectors and phase shifts at four thermal grating separations, and finally it calculates the stress based on a least squares fit of the phase shifts versus separation providing the stress as a portion of output 196.

The analytical equations relating the measured signals to the Stokes parameters for the case of ideal components and exact alignment can be found in “Ferroelectric Retarders as an Alternative to Piezoelestic Modulators for Use in Solar Stokes Vector Polarimetry,” by M. Gandofer, Opt. Eng. 38, 1402-1408 (1999) which is hereby incorporated by reference. Since the FLC waveplates 182 and 186 are not ideal, these equations are only approximate and so the detector 180 is calibrated.

During calibration, a fixed crystal polarizer followed by a Babinet-Soliel compensator is used to generate known polarizations that are measured with the Stokes meter of FIG. 4. Four linear polarizations, horizontal, vertical, +45°, and −45°, and plus and minus circular polarization, are used. These polarizations correspond to the Stokes vectors (1,1,0,0), (1,−1,0,0), (1,0,1,0), (1,0,−1,0), (1,0,0,1), and (1,0,0,−1) respectively. The four row vectors of the 4×4 matrix that gives the best fit of the measured signal are found with a regression macro (Microsoft Excel's Data Analysis Tool Pack) using the Q, U, and V components of the Stokes vectors describing the input polarizations as the independent variables. The matrix inversion function in Excel was used to calculate the inverse of this 4×4 matrix to give the calibration matrix. The product of this calibration matrix and the 4-vector of measured signals then gives the measured Stokes vector for light of an unknown polarization.

To calibrate the double thermal grating method of measuring stress, a small sample of annealed Tint glass was mounted in a rectangular steel frame. The glass was 48.90 mm wide by 41.28 mm high by 3.302 mm thick and was mounted between the bottom of the steel frame and a piece that slid in the grooves in the sides of the frame. A 0.75-inch diameter lead screw with an Acme thread (10 threads per inch) that was threaded through the top side of the frame pushed on a load cell (Omega Model LC304-5k) that pushed on this slider. The glass was mounted in adapters made from 0.25″ square steel stock that had slots milled in them that allowed about 0.254 mm clearance for the glass and these slots were filled with Wood's Alloy to fill gaps and allow a uniform pressure to be applied to the top and bottom edges of the glass. These adapters fit in matching slots in the bottom of the frame and the slider. The stress in the glass was measured by use of a Babinet-Soliel compensator to measure the birefringence seen by light traveling through the glass normal to the faces.

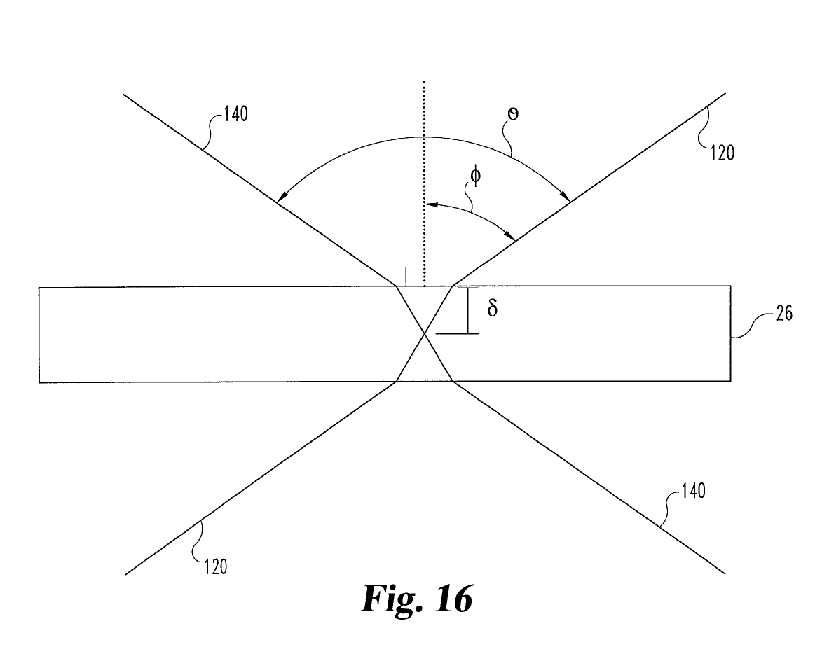

In a preferred embodiment, the sensor 99 is provided with means for monitoring and controlling the alignment of the probe and writing beams to control the location and orientation of the generated singly deflected beam. For beams 120 and 140 aligned in a plane, there are two angles and one distance that control the generation of the singly deflected beam at the center of the thickness and traveling parallel to the surface of the glass sheet. With reference to FIG. 16, these are the angle in air between beams 120 and 140, designated θ, the orientation of these two beams relative to the normal of the glass, designated φ, and the distance from the first surface 26a of the glass to the intersection of the beams, designated δ.

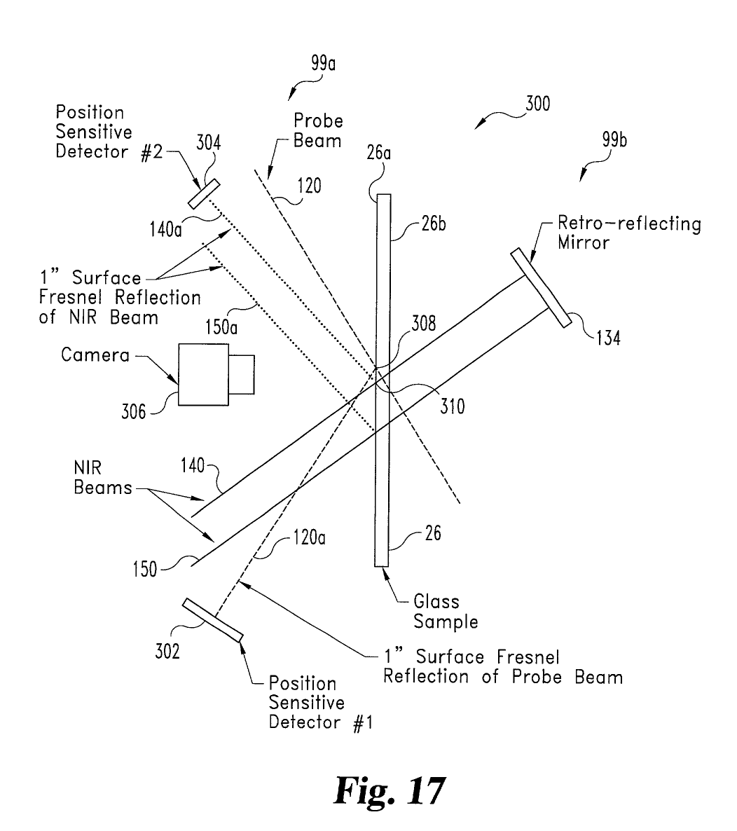

Turning now to FIG. 17, an alignment system 300 is depicted. System 300 includes position sensitive light detectors 302 and 304 and camera 306. Detector 304 senses beam 140a which is the Fresnel reflection of writing beam 140 off of the first surface 26a of glass 26. Similarly, detector 302 receives beam 120a which is the Fresnel reflection of probe beam 120 off surface 26a. Camera 306 is directed toward the glass 26 and captures the location of spots 308 and 310 where beams 120 and 140 respectively intersect surface 26a. Detectors 304 and 302 and camera 306 are positioned in a predetermined fixed relation to each other and to the glass 26.

Based on the positions where beams 140a and 120a intersect the detectors 304 and 302, the determined relative location of spots 308 and 310, and the known geometry of the apparatus, the angle between beams 120a and 140a, and consequently the angle θ between beams 120 and 140 can be determined. In similar fashion, angle φ can also be determined. With the angle θ known and the relative separation of spots 308 and 310 also known, the depth of the intersection of the beams δ can then be determined.

Adjustments of angle φ and depth δ can be made either by moving the glass 26 and keeping the optical system fixed or by keeping the glass 26 fixed and moving the optical system. One way to move the optical system would be to mount it on, for example, an articulated arm (not shown). It is also possible to use a combination of these two techniques where for example the depth δ is controlled by a linear translation of the optical system and the angle φ is controlled by tipping the glass system.

Adjustments to angle θ can be done in any conventional fashion. One preferred method includes translating the probe beam 120 before the lens that focuses it on to the glass sample, for example lens 128 in FIG. 2. Because the lens is focusing beam 120 at a point in space, translating the probe beam before the lens will produce pure rotation of that beam about that point in space. One way to create the translation is with a moveable a mirror, such as mirror 124. Alternatively or in addition, a tilt plate, which is a thick parallel place of glass or other clear optical material that can be rotated about an axis where such a rotation will cause a translation of a light beam without introducing an angular deviation, can be used.

A similar approach can be applied to beam 140, though it is made more complicated in the case where beam 140 is split to form a pair of writing beams (see FIG. 2). In addition, alteration of the angle of beam 140 might necessitate adjustment of the retro reflecting mirror 134. Other possibilities for moving any of the beams include the use of motorized actuators on a mirror mount to tilt the mirror combined with translation of a the same or a different mirror to change the angle between the beams without also changing the depth δ.

Preferably, in system 300 detectors 302 and 304 and camera 306 are adapted to send their output to a controller (not shown) and/or a computer, such as computer 194, for processing and control. Detectors 302 and 304 can be segmented photodiode arrays, and camera 306 can be a digital cameral. The controller and/or computer is adapted to processes the outputs of the detectors and camera, calculate the angles θ and φ and depth δ, and take any corrective action to maintain the angles and depth at the desired values. In addition, since deviation of the angles θ and φ and depth δ from their desired values can adversely affect signal strength, the strength of the light signal received at sensor 180 can also be used as a measure to check the alignment as a part of a feedback control loop.

To have the efficiency be greater than 50% of maximum for the geometry and beam properties described herein, Snell's law predicts that the tolerance for θ is ±0.85 mrad and the tolerance for φ is ±29 mrad. Thus, the angle 74 between beams 120 and 140 is more critical that the orientation of the surface normal relative to the beams. Controlling the distance δ in the glass to ±0.2 mm, which is 5% of the thickness of the tempered glass samples used above, requires controlling the position to ±0.1 mm.

The efficiency with which a thermal grating in glass deflects light is important since the signal level is proportional to the square of this efficiency. To guide in optimizing this efficiency, a model for the deflection efficiency was developed. In the illustrated embodiment, the thermal grating is formed by a 1064 nm beam from a pulsed Nd:YAG laser that passes through the glass sample and is retro-reflected back to setup a standing wave in the sample with a spatial period of 1064 nm/2n=352 nm where n is the refractive index at 1064 nm and equals 1.51 for soda-lime glass. Energy absorbed from this spatially and temporally varying light field is the heat source that creates the periodic temperature variation in the glass that causes a periodic variation in the refractive index. This periodic variation in the refractive index is the thermal grating and it has the same period as the standing wave.

To develop the model, those processes that are fast enough to contribute to changes in the refractive index during the laser pulse are first identified. Second the temperature distribution in the thermal grating as a function of time is modeled. Third this temperature distribution is converted into a refractive index distribution that can be inserted into an expression for the diffraction efficiency of a volume grating. Finally this efficiency is integrated over the duration of the laser pulse to calculate the net deflection efficiency. The sub-sections below describe these steps.

Timescales

There are three lengths that are important in determining the timescales on which the thermal grating changes; the period of the standing wave, the radius of the writing beam, and the pathlength through the glass, which is the glass thickness divided by cos (30°) and is about 3.8 mm for the samples of glass used. The thermal relaxation rate of a one-dimensional sinusoidal temperature variation, kₜₕₑᵣₘₐₗ is given by

$${k}_{thermal} = \frac{4 {π}^{2} {D}_{th}}{{Λ}^{2}}$$

where Dₜₕ is the thermal diffusivity of the material and Λ is the period. For a thermal diffusivity for soda-lime glass of 4.5×10⁻³ cm²s⁻¹, and 353 nm as the period of NIR standing wave in the glass, this gives a rate of 1.4×10⁸ s⁻¹, which is significant on the time scale of the NIR laser pulse. In addition, the amplitudes of the sinusoidal temperature variation can vary significantly over the 6-7 ns duration of the green pulse depending on the delay between the near infrared (NIR) and green pulses arriving at the sample. Thus this thermal relaxation is included in the model. In contrast, the characteristic timescale for radial thermal diffusion is approximately ω₀²/4Dₜₕ which, for a beam radius of 0.35 mm, is 0.07 second and is not significant during the laser pulse. Similarly thermal diffusion from the front to the back of the glass is too slow to matter during the laser pulse.

In addition to changes in refractive index due to temperature changes, the index can change due to density changes, which propagate at the speed of sound. An acoustic longitudinal compression wave has a velocity in glass of about 5000 m/s, which gives timescales of 70 ps, 50 ns, and 760 ns for changes in the density on the length scales of respectively the grating period, the beam radius, and the glass thickness. Thus density changes with the period of the grating will be in steady state with the temperature changes while the other density changes can be neglected as being much slower than the laser pulse.

Temperature Distribution

To model the temperature distribution of a thermal grating, we choose the origin of the coordinate system as the point where the center of the 1064 nm beam from the laser intersects the first surface (the top surface in FIG. 2) of the glass and the direction of the z-unit vector to match the propagation vector of this beam. The electric fields of the 1064 nm beam in the glass traveling forward, E_{f}(r,t,z) and traveling backward, Eᵣ(r,t,z) are modeled as

$${E}_{f} ( r , t , z ) = E ( r , t ) exp ( - \frac{A}{2} z + ikz )$$

$${E}_{r} ( r , t , z ) = E ( r , t ) exp ( - \frac{A}{2} d ) ( 1 - R ) exp ( - \frac{A}{2} ( d - z ) - ikz )$$

where A is the power absorption coefficient, d is the glass thickness along the z-axis, which is the thermal grating axis, R is the power reflection coefficient at the back face, k is the wavevector, and E(r,t) contains the transverse and temporal dependences of the laser pulse. We assume that the Rayleigh range is much longer than the distance from the glass to the retro-reflecting mirror so that the divergence of the beam can be neglected. Summing these two fields and calculating the square of the magnitude yields the irradiance, which is composed of two terms. One is a sinusoidal variation of constant amplitude through the glass,

I_{g}(r,t,z)=2(1−R)exp(−Ad)cos(2kz)I(r,t), (1)

which produces the thermal grating, and the other is a decaying term.

I_{DC}(r,t,z)=└exp(−Az)+(1−R)²exp(−A(d−z)┘I(r,t) (1a)

that we neglect in the rest of this model. The absorbed power that formns the thermal grating is I_{g}(r,t,z)×A, which has units of watts/cm³. We model the transverse distribution as Gaussian and the temporal shape of the pulse as the difference between two exponentials by using

$$I ( r , t ) = \frac{2 {E}_{NIR}}{{πω}^{2}} exp ( - 2 {( \frac{r}{ω} )}^{2} ) ( \frac{ab}{b - a} ) ( exp ( - at ) - exp ( - bt ) ) \qquad ( 2 )$$

where E_{NIR} is the pulse energy and ω is the beam radius. The parameters a and b define the shape of the laser pulse and are 4×10⁸ s⁻¹ and 3×10⁸ s⁻¹ respectively. This is not the exact time dependence of the pulse, but it does have the rapid rise, slower decay and the same full width at half maximum that are characteristic of the real pulse shape.

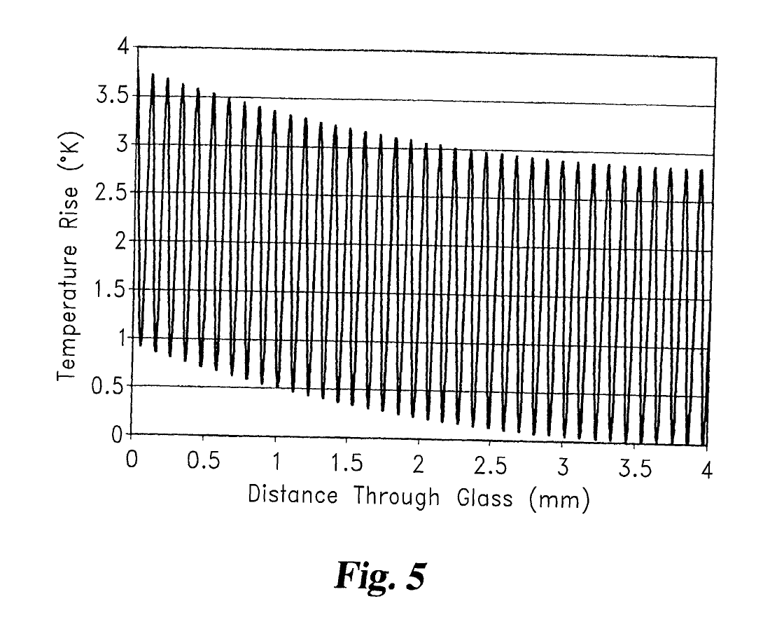

FIG. 5 shows an example of a calculated temperature distribution that neglects thermal diffusion for Visteon Tint glass with pulse energy of 6 mJ, a 0.7 mm diameter beam at the sample, and with the polarization of the NIR beam chosen for minimum reflection at the surfaces. To show the sinusoidal temperature distribution on the same scale as the glass thickness, the period of the standing wave was increased by a factor of 300. With neglect of thermal diffusion, the on-axis amplitude of the sinusoidal term is given by

$$Δ T = ( \frac{2 {E}_{NIR}}{{πω}^{2}} ) ( \frac{A}{{C}_{p} ρ} ) [ 2 ( 1 - R ) exp ( - Ad ) ]$$

where Cₚ is the specific heat capacity of the glass and ρ is the density. This amplitude is reduced by thermal diffusion.

We include the time variation of the heat deposition from the NIR laser pulse, decay of the thermual grating by thermal diffusion, and arrival time and duration of the green pulse by using the one dimensional heat equation

$$\frac{\partial T ( t , z )}{\partial t} - {D}_{th} \frac{{\partial }^{2} T ( t , z )}{\partial {z}^{2}} = H ( t , z )$$

where T(t,z) is the temperature difference from ambient as a function of time, t and distance through the glass, z. H(t,z) is the heat source term, which is given by

H(t,z)=AI(r=0,z,t)/Cₚρ

where I(r=0,z,t) is given by Eq. (1) and which we write as

H(t<0,z)=0

H(t>0,z)=H₀ cos(2kz)[exp(−bt)−exp(−at)]

where H₀ is a constant that includes the NIR pulse energy, absorption coefficient, and the heat capacity and has units of K/s. With this heat source term, the heat equation can be solved analytically to give

$$T ( t , z ) = {H}_{0} cos ( 2 kz ) [ \frac{\begin{matrix}( c - b ) exp ( - at ) + ( a - c ) exp ( - bt ) + \\ ( b - a ) exp ( - ct )\end{matrix}}{( b - c ) ( c - a )} ] \qquad ( 3 )$$

where c=4k²Dₜₕ. We convert Eq. (3) into an expression for the time variation of the refractive index profile.

Refractive Index Variations

At steady state the periodic stresses along the thermal grating due to temperature and density variations are zero, thus

$${( \frac{\partial {S}_{z}}{\partial T} )}_{ρ} δ T ( z ) = - {( \frac{\partial {S}_{z}}{\partial ρ} )}_{T} δρ ( z )$$

where S_{z} is the stress along the grating axis z, T is temperature, ρ is density, δT(z) is the variation of temperature along the grating, and δρ(z) is the variation of density along the grating. This can be rearranged to

$$δρ ( z ) = - {( \frac{\partial ρ}{\partial {S}_{z}} )}_{T} {( \frac{\partial {S}_{z}}{\partial T} )}_{ρ} δ T ( z ) = {( \frac{\partial ρ}{\partial T} )}_{{S}_{z}} δ T ( z ) = - ραδ T ( z )$$

where α is the linear coefficient of thermal expansion. For soda-lime glass, α is 9.2×10⁻⁶ K⁻¹ and ρ is 2.55 g/cc. Thus the variation in the refractive index along the thermal grating, δn(z) can be express in terms of δT(z) by

$$δ n ( z ) = {( \frac{\partial n}{\partial T} )}_{ρ} δ T ( z ) + {( \frac{\partial n}{\partial ρ} )}_{T} ( - αρ ) δ T ( z ) \qquad ( 4 )$$

where the first partial derivative is the change in refractive index with temperature at constant density and the second is the change in n with density at constant temperature.

The quantities ρ(∂n/∂ρ)_{T} and (∂n/∂T)_{ρ} can be determined from the pressure dependence of the refractive index, dn/dp and the temperature dependence, dn/dT, using the equations

$${ρ ( \frac{\partial n}{\partial ρ} )}_{T} = \frac{1}{β} ( \frac{ⅆ n}{ⅆ p} )$$

$$\frac{ⅆ n}{ⅆ T} = {( \frac{\partial n}{\partial T} )}_{ρ} - {γρ ( \frac{\partial n}{\partial ρ} )}_{T}$$

where β is the compressibility and γ is the volume coefficient of expansion. This last equation shows that dn/dT is the difference between two effects; the first reflecting the increase in n with temperature at constant density and the second reflecting the change in n due to thermal expansion and the resulting change in density. Thus dn/dT can be positive or negative depending on which effect dominates. This equation for dn/dT differs from that for δn(z)/δT(z) from Eq. (4) only by the factor of 3 difference between the linear and volumetric coefficients of expansion.

The values of (∂n/∂T)_{ρ} and ρ (∂n/∂ρ)_{T} for five commercial laser glasses for the wavelength 643.8 nm have been reported as ranging between 0.64-1.03×10⁻⁵ K⁻¹ and 0.30-0.36 respectively. The values of (∂n/∂T)_{ρ} and ρ (∂n/∂ρ)_{T} at 587.6 nm for fused silica are 0.91×10⁻⁵ K⁻¹ and 0.32 respectively. While these values are all for silicate glasses, none of these glasses is a close match in composition to the automotive float glass samples from Visteon that were used in this work.

In fact these laser glasses have negative values of dn/dT in contrast to the positive values for soda-lime float glass. However, these are the only values that were found for silicate glasses. No systematic studies of the effect of composition on (∂n/∂T)_{ρ} and ρ (∂n/∂ρ)_{T} were found, but composition can have a pronounced effect on ∂n/∂T. In soda-lime glasses with weight percent compositions of (25-x)Na₂O, (x)CaO, and (75)SiO₂, dn/dT changes from −3.95 for x=0 to +2.87 for x=10 in units of 10⁻⁶ K⁻¹. In a study comparing a soda-lime glass without iron to one with 2% Fe₂O₃, the change in optical path length with temperature, ds/dT was measured using a thermal lensing technique. The effect of the iron was to increase ds/dT by more than a factor of 2. Since ds/dT depends on the thermal expansion coefficient, dn/dT, and the stress optical coefficients, this result raises the question of the effect of the iron content in different types of automotive glass on the deflection efficiency of thermal gratings.

As an estimate, we use values of 0.8×10⁻⁵ K⁻¹ for (∂n/∂T)_{ρ} and 0.34 for ρ (∂n/∂ρ)_{T}, which yields 5×10⁻⁶ K⁻¹ for δn(z)/δT(z). This estimate has a substantial uncertainty associated with it whose effect is magnified since the deflection efficiency depends on the square of δn(z)/δT(z). It is understood that this uncertainty could be resolved with a more accurate measurement or determination of the values for the parameters.

Deflection Efficiency

We use the equation for a plane holographic grating with a finite thickness, L_{eff}, that has a sinusoidal variation in the refractive index with an amplitude n₁, and is in a medium with average refractive index n₀. (See H. Kogelnick, “Coupled wave theory for which hologram gratings,” Bell System Tech. Journal, 48, 2909-2947 (1969)) This model gives the deflection efficiency, η(t) at the optimum angle (the Bragg angle) of

$$η ( t ) ≅ \frac{4 {π}^{2} {{n}_{1} ( t )}^{2} {L}_{eff}^{2}}{3 {λ}^{2}} \qquad ( 5 )$$

where η<<1 and λ is the wavelength of the green beam, 532 nm. For L_{eff} we use the beam radius of the NIR beam, the beam radius being defined as the radial distance where the intensity is down to 1/e² of the maximum intensity, and for n₁(t) we use δn(z) from Eq. (4) with δT(z) given by T(t) from Eq. (3).

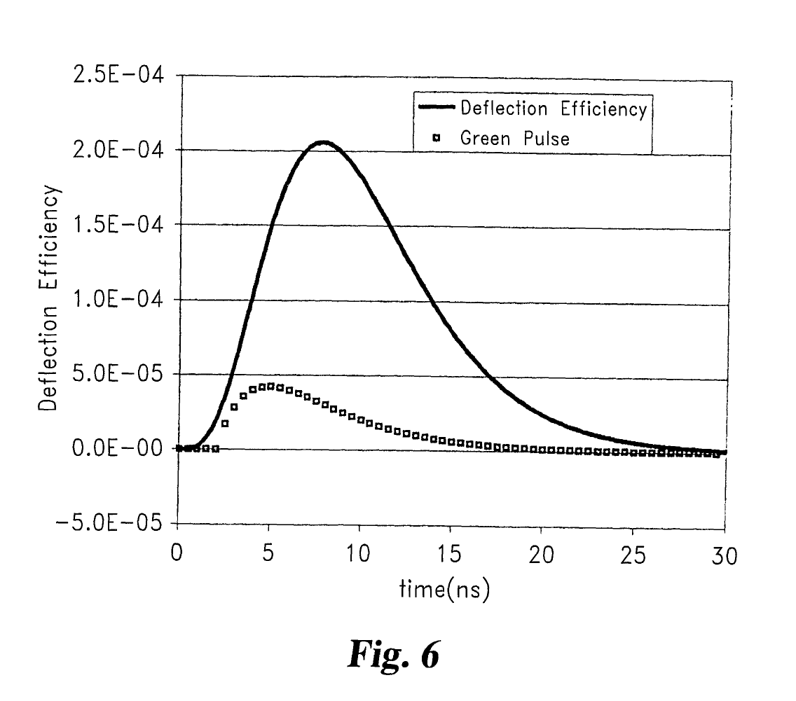

The product of the green pulse shape, delayed by an amount Δt from the NIR pulse, and the deflection efficiency as a function of time was integrated to give the net deflection efficiency. FIG. 6 shows the time dependent deflection efficiency calculated from this model for a NIR pulse energy of 6 mJ, a 4 mm path through the glass, an absorption coefficient matching that of Tint glass (0.273 mm⁻¹, see Table 1 below), and δn/δT of 5×10⁻⁶K⁻¹. The pulse shape of the green beam with the experimental 2 ns delay with respect to the NIR beam is also shown where we have assumed the same temporal dependence as for the NIR pulse except for a time delay.

We numerically integrated the product of the time dependent diffraction efficiency, η(t), times the green laser pulse shape to determine the net deflection efficiency. From the model, the optimum delay is 3.8 ns, which increases the calculated net efficiency from 1.4×10⁻⁴ to 1.6×10⁻⁴. We note that, having included the dynamics in the model, the calculated deflection efficiency is reduced by a factor of about 6 from a simple model that neglects thermal diffusion and the time variation of the laser pulses.

In practice, delays between the arrival of the writing and probe beams at the glass surface greater than about 1 ns, more preferably at least about 2 ns, and most preferably over 3 ns can be used. In other embodiments, delays equal to at least about 5% of the beam pulse width, for example between 10% and 90% can be used. It is also possible to use a negative delay, wherein the probe pulse arrives before the writing beam, so long the delay is not less than −2 times the full width at half maximum of the probe pulse such that there is some effective overlap between the light beams in the glass. In addition, using the glass and laser setup described above, if the time delay were more than about 30 ns, then the efficiency would be reduced by a factor of 100, which would make the measurement difficult. For materials like plastics that have lower thermal diffusivites than glass, larger delays can be tolerated without excessive loss of signal. A more general limit on the maximum acceptable delay is about 5 times 1/kₜₕₑᵣₘₐₗ, where kₜₕₑᵣₘₐₗ is the thermal relaxation rate for a one-dimensional sinusodial temperature variation in the material given by the formula above.

Efficiency and Power Scaling

The scaling of the efficiency with MR pulse energy and beam diameter (2L_{eff}) can be found from Eq. (5) by noting that the refractive index grating amplitude, n₁(t) is proportional to the amplitude of the temperature grating, which in turn is proportional to the NIR pulse energy divided by L_{eff}². Thus the efficiency scales as

$$η ∝ {( \frac{{E}_{NIR}}{{L}_{eff}^{2}} )}^{2} {L}_{eff}^{2} = \frac{{E}_{NIR}^{2}}{{L}_{eff}^{2}} \qquad ( 6 )$$

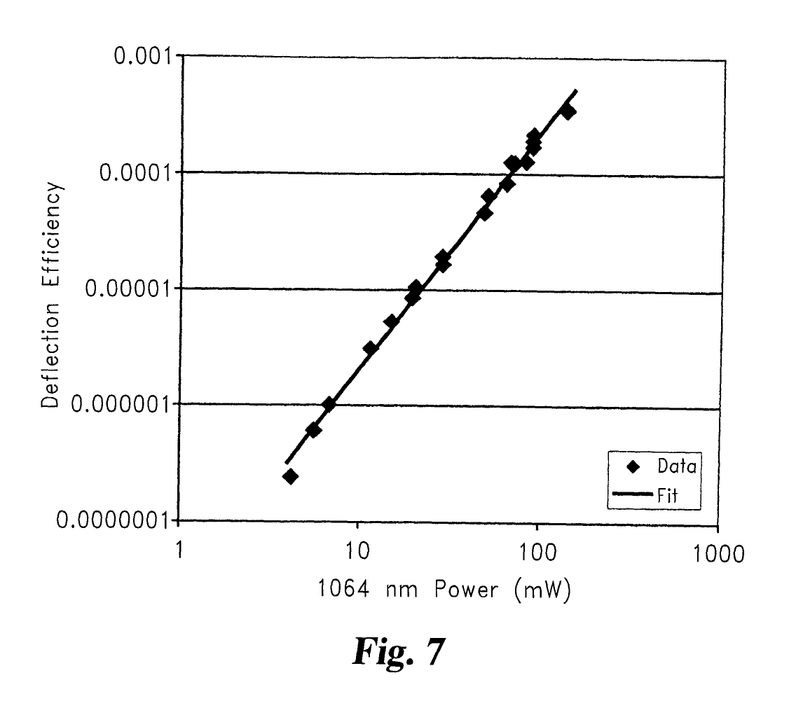

for L_{eff} much larger than the probe beam diameter and where none of the effects discussed below in the section titled “Limitations on Achievable Deflection Efficiency” are significant. FIG. 7, which shows the deflection efficiency versus NIR power, shows that the deflection efficiency scales as the 2.04±0.04 power of the NIR average power for pulse energies up to 14 mJ per pulse, in agreement with Eq. (6). These data were taken with the beam splitter that splits the NIR into two beams removed. We also confirmed that the deflection efficiency is independent of green pulse energies up to 4 mJ per pulse. We did not observe deviations from the scaling with pulse energy predicted in Eq. (6) in these experiments, though, as described below, there are effects that will limit the deflection efficiency at higher pulse energies and/or smaller NIR beam diameters.

At 60 mW of NIR power, corresponding to 6 mJ per pulse, the measured deflection efficiency is 8×10⁻⁵ compared with the prediction from the model for the same conditions of 1.4×10⁻⁴. Several factors may contribute to this disagreement. The largest uncertainty is the value for δn(z)/δT(z) as described above. Another possible source is the approximation of a Gaussian distribution as a square pulse that is inherent in using Eq. (5). Finally, the phase fronts of the thermal grating or the green beam may not have been flat as a result of aberrations in the laser beams, the beam waists not being positioned exactly at the sample, and/or inhomogeneity in the refractive index of the glass sample. The scaling with beam diameter was not tested.

From Eqs. (1) and (5), the relative deflection efficiency for different types of float glass should vary as A² exp(−2A d) if the heat capacity, density, and δn(z)/δT(z) are constant among the compositions.

TABLE 1
Predicted and Measured Relative Deflection Efficiencies

| | NIR | | Predicted | Measured |
|---|---|---|---|---|
| | Absorption | Green | Relative | Relative |
| | Coefficient | Absorption | Deflection | Deflection |
| Glass Type | (m⁻¹) | Coefficient (m⁻¹) | Efficiency | Efficiency |
| Clear | 64.6 | 5.4 | 0.211 | 0.15 |
| Tint | 273 | 24.7 | 1.000 | 1.00 |
| Solar Tint | 439 | 43.7 | 0.685 | 0.76 |
| Batch Privacy | 663 | 457 | 0.26 | 0.21 |

Table 1 shows the predicted deflection efficiencies relative to Tint glass based on absorption coefficients provided by Visteon for their glasses and our measured results for the relative efficiency. The measured values are corrected for absorption of the deflected green beam using the absorption coefficients for 530 nm. All the glass types in Table 1 are samples from Visteon except the “Clear” glass sample, which is a sample of 6 mm thick window glass for buildings whose NIR absorption coefficient was measured by us. The predictions of our model agree quite well with the measured values, which provides evidence that the variation of δn(z)/δT(z) with composition among these glasses is minor. The measurement for Batch Privacy has the largest potential error because the large absorption coefficient for green light magnifies the effect of errors in measuring the path length from the thermal grating to the edge of the sample.

Implicit in our model is the assumption that energy absorbed from the NIR standing-wave creates a change in refractive index on a timescale much faster than the laser pulse. We assume that this refractive index change occurs by a thermal mechanism. We tested this assumption with a thermal lens experiment. We crossed a focused red helium-neon laser beam with the NIR beam at a small angle in the glass. The part of the red beam transmitted through a small aperture was detected by a fast photodiode and recorded on a digital oscilloscope. The thermal lens generated by the NIR beam in the glass deflected the path of the red beam and so changed the amount of light reaching the photodiode. The change in the photodiode signal had a rise time of less than 10 ns, the sampling rate of the digital oscilloscope, which confirmed that the change in refractive index happens on a timescale at least as fast as the NIR laser pulse.

Limitations on Achievable Deflection Efficiency

Eq. (6) leads one to think that with smaller NIR beams and higher pulse energies the deflection efficiency can be increased to near 100%. Especially with the NIR beam size, there appears to be a win-win situation since a smaller NIR beam at the sample (that is, smaller L_{eff}), gives higher deflection efficiency and better depth resolution. However, there are at least four effects that start causing problems as L_{eff} is reduced. The first is the difficulty in aligning the green beam to intersect the thermal grating as the diameter of the thermal grating gets smaller. The second is the damage threshold of the glass; at fluences (pulse energy per unit area) above a threshold, a plasma forms on the surface where the laser beam enters the glass that damages the surface. This threshold depends on wavelength, pulse duration, glass type, and surface preparation. We measured the damage threshold to be 60 J/cm²±30% for clear float glass with our NIR laser by focusing the NIR laser beam down to a 0.13 mm diameter with a 250 mm focal length lens and measuring how close to the focus we could place the glass before observing a plasma. The peak fluence was calculated as 2 E_{NIR}/πω²r, where ω is the beam radius and the beam profile is Gaussian. For the thermal grating experiments, where we used a maximum of 14 ml in a 0.7 mm diameter beam, the maximum fluence used was 7 joules/cm², which is well below the damage threshold.

The third effect that causes problems as the NIR beam size is reduced is thermal lensing of the NIR beam. We discovered that this is a problem while trying to measure the damage threshold of Tint glass. We observed plasma formation on the exit surface of the glass sample and not the entrance surface. Calculations of self-focusing of laser beams predict that even with adsorption losses, focusing due to thermal lensing can double the maximum laser beam intensity for 2 mJ in a 0.13 mm diameter beam, using the adsorption coefficient of Tint glass at 1064 nm. The heating and subsequent refractive index change from absorption of the early part of the NIR laser pulse creates a focusing lens in the glass, with a power proportional to E_{NIR}/ω⁴, that can focus the latter part of the pulse. In the extreme case, this focusing can increase the intensities to the point where they cause damage on the exit surface or even in the middle of the glass.

Even when thermal lensing doesn't damage the glass, the focusing can greatly reduce the deflection efficiency by two mechanisms. Thermal lensing bends the wavefronts of the NIR beam during the pulse, which reduces the amplitude of the thermal grating, and with bent wavefronts only a part of the thermal grating is at the Bragg angle to the green beam for strong constructive interference. However, with a 0.7 mm diameter NIR beam rather than the 0.12 mm beam used in the damage threshold measurements, thermal lensing is reduced by a factor of 840, for the same pulse energy. The calculated decrease in beam diameter after traversing the glass is 0.05%, which is too small to cause an increase in irradiance because of the absorption losses.

The fourth effect that limits the deflection efficiency is thermally induced phase shifts in the standing wave. The temperature change during the first part of the laser pulse and the resulting change in the refractive index will change the NIR wavelength in the glass. If this temperature change is too large, then the positions of the maxima and minima of the standing wave will switch thus reducing the amplitude of the thermal grating and the deflection efficiency. Integrating the product of the total temperature change on axis (I_{DC}(r=0,t=∞,z)A/ρC_{ρ}) times (∂n/∂T)_{ρ} through the thickness of the glass gives the net change in optical pathlength during the laser pulse. For 3.3 mm thick Tint glass, this optical pathlength change is 0.14 wave for a 6 mJ pulse with a 0.7 mm diameter. This optical pathlength change should increase as inverse of the beam area and linearly in the pulse energy and reach ½ wave for pulse energies of 22 mJ for this beam diameter. The fact that there is no reduction in efficiency observable in FIG. 7 probably reflects the fact that this is a worst-case estimate.

Polarization Behavior

We tested the dependence of the polarization of the deflected beam on the polarization of the incident beam in pieces of annealed glass with a smooth edge. The thermal grating was placed about 7 mm from the edge to minimize any polarization changes due to residual stresses. For a linearly polarized incident green beam, the diffracted beam exiting through the edge was also linearly polarized with extinction ratios, Iₘₐₓ/Iₘᵢₙ, of 200-1000. If the incident green beam was horizontally polarized, that is in the plane of the green and NIR beams, or vertically polarized, then the deflected beam was polarized along the same direction. For an incident polarization at 45° from vertical, the deflected beam was polarized at 36°±1° from vertical, which was consistent with the larger deflection efficiency for vertical polarization rather than horizontal polarization. The lack of ellipticity in the polarization suggests that the diffraction by the thermal grating does not introduce any phase shift between the vertical and horizontal components of the light.

Beam Profiles

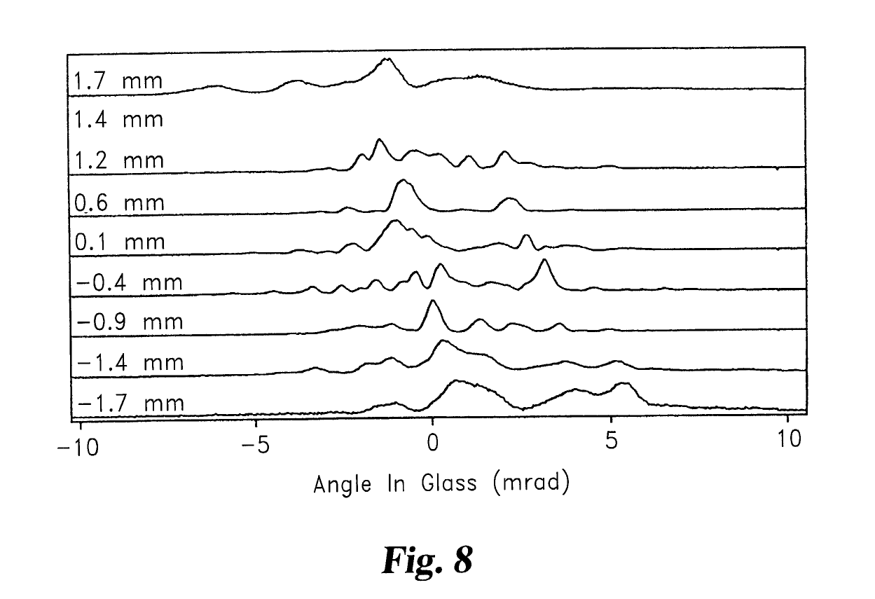

FIG. 8 shows the profile of the singly deflected beam in the horizontal plane as a function of depth through the glass from a thoroughly annealed piece of Tint glass that has surface stresses of 0±100 psi as measured with a laser based grazing angle surface polarimeter (Laser-GASP, Strainoptic Technologies, Inc.). These profiles were measured by directing the beam exiting the polished edge of this sample onto a linear diode array (EG&G Reticon Model RC1000, pixel dimensions 2.5 mm high by 25 μm wide) and converting the displacements on the array to angles in the glass by dividing by the distance and the refractive index. The angles are approximate since the polished edge has a slight curvature and the zero angles are only approximately equal to being parallel to the surface of the glass. The corresponding divergence in the vertical plane was a fraction of a milliradian. This qualitative behavior is seen with all glass samples that have an edge that is smooth enough to allow the light to escape as a beam, though measurements on an annealed clear glass sample showed much less distortion of the beam. Even well away from the surfaces these beams have complicated structure in the horizontal plane. Except for near the surfaces, these curves all have approximately the same area. The amount of divergence in the horizontal plane in even the worst case does not significantly increase the size of the singly deflected beam over the typical 15 mm distances between thermal gratings. However, theses divergences do exceed the full with at half maximum acceptance angle for Bragg scattering from these thermal gratings, Δθ that is given by

Δθ≅\sqrt{2}λ/πnL_{eff}

and equals 0.9 mrad for L_{eff} of 0.35 mm.

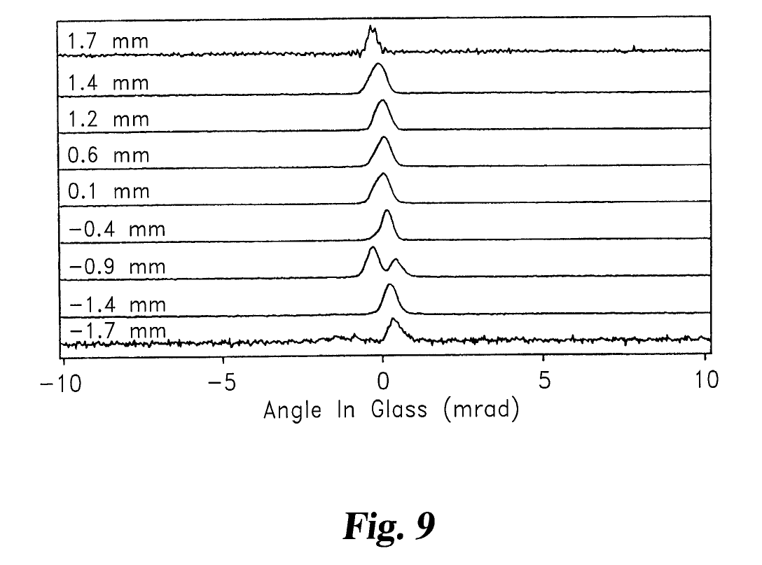

We do not understand the cause of these beam shapes, but it appears to be related to the distance and/or the direction the beam travels through the glass sample. The profiles of the doubly deflected beams have much smaller divergences and usually only a single maximum as shown in FIG. 9. These doubly deflected beams were recorded immediately before those in FIG. 8 and with no change in sample or alignment of the NIR and probe beams. It is possible that this beam distortion is due to fluctuations in the refractive index with depth that is analogous to beam breakup due to atmospheric turbulence. The process of drawing the molten glass from the tin bath into a sheet would tend to make composition more uniform in planes parallel to the surfaces, but not through the thickness. This is only a supposition and we have not studied these beam shapes in enough detail to come to any conclusions.

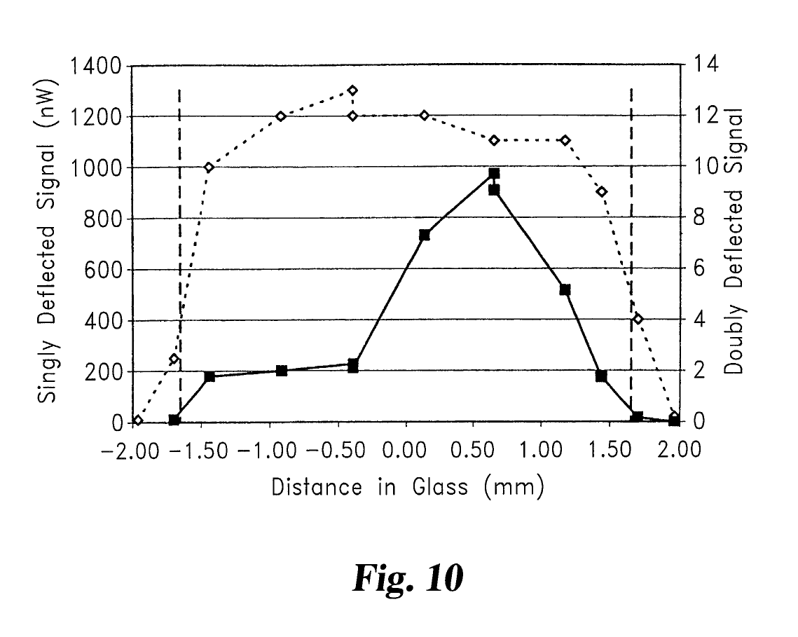

FIG. 10 shows the dependence of the singly and doubly deflected signals versus depth using the areas from FIG. 9 for the doubly deflected signals and power measurements taken at the same time on the singly deflected signals. The maximum doubly deflected signal occurs at a depth of 0.6 mm from the middle of the glass, which corresponds to the cleanest singly deflected beam profile in FIG. 8. This is consistent with the narrow angular acceptance for Bragg scattering from the second thermal grating. At the optimum depth and with careful alignment, the efficiency of converting the probe beam into doubly deflected signal approaches 7×10⁻⁸ in Tint glass with our experiment. This is comparable to the product of the two efficiencies predicted by our model for the 6 mJ and 9 ml pulses energies, 1.4×10⁻⁴ and 3.2×10⁻⁴, but almost a factor of 5 high than the expected efficiency based on the observed deflection efficiency from a single thermal grating.

In tempered glass samples, the power in the singly deflected beam is approximately constant with depth in the glass except for near the surfaces, just as in annealed glass as shown in FIG. 10. However the deflection efficiency is lower in tempered glass than in annealed glass. The depth dependence of the doubly deflected signal in tempered glass is much sharper than in annealed glass and often shows two maxima of different heights. These variations in doubly deflected signal with depth vary with position in the sample.

Scattered Light

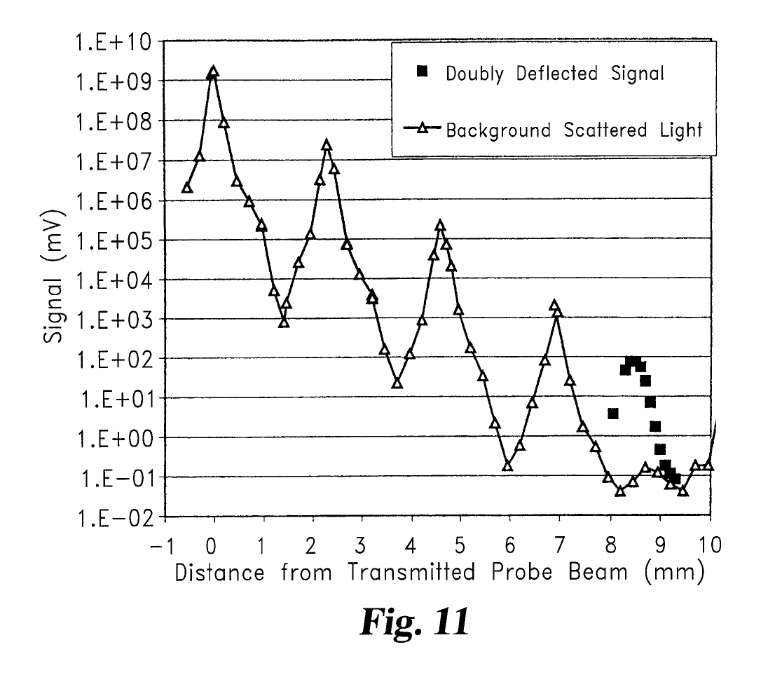

FIG. 11 shows a measurement of the background of scattered 532 nm light above which we detect our doubly deflected signal. These data were collected using just a photodiode as the detector and by translating mirror 145 in FIG. 2 to vary the separation of the optical axis of the detection from the axis of the transmitted probe beam. Neutral density filters were used to reduce the signal levels to within the dynamic range of the detection system and the plotted signal levels were corrected for their transmissions. The peak at zero is the transmitted probe beam and the subsequent peaks are beams that are parallel to the probe beam and that are created by a pair of Fresnel reflections at air-glass interfaces from the previous beam. For example, the Fresnel reflection of the probe beam at the exit surface of the glass creates a beam that undergoes Fresnel reflection at the entrance surface of the sample that creates the beam the causes the peak at about 2 mm. It is these reflections that determine the minimum useable separation between thermal gratings. With thicker glass samples, it should be possible to make measurements at smaller separations, that is between these peaks. For example, if the glass were about 3 cm thick, it is expected that thermal grating separations less than the material thickness could be readily employed. FIG. 11 also shows the size of a doubly deflected signal on the same scale.

Stress Measurement Calibration

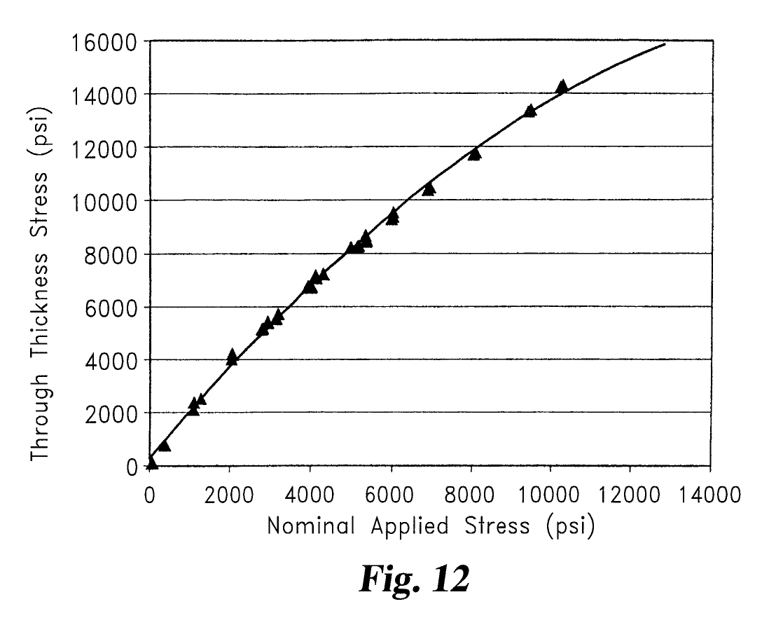

Given the unexplained beam shapes of the singly deflected beams and the variation in signal strength of the doubly deflected beam with depth in the glass, it was important to confirm that the double thermal grating technique was in fact measuring stress and to calibrate those measurements. FIG. 12 shows the stress determined by measuring the birefringence in the test glass samples in our calibration frame versus nominal applied stress, applied force measured by the load cell divided by the cross sectional area of the glass sample. These results are for light traveling normal to the face and through the middle of the faces of the sample and use a stress optic coefficient of 2.68×10⁻¹² Pa⁻¹. The downward curvature of the plot indicates the force is not uniformly distributed over the glass and is concentrated in the center. The line is a quadratic fit to the data. Here in the center of the sample, the stress was uniform as measured by the birefringence, but even about 1 cm from the edge, the stress was much less uniform and weaker. Thus the stress was not uniform across the width of the glass.

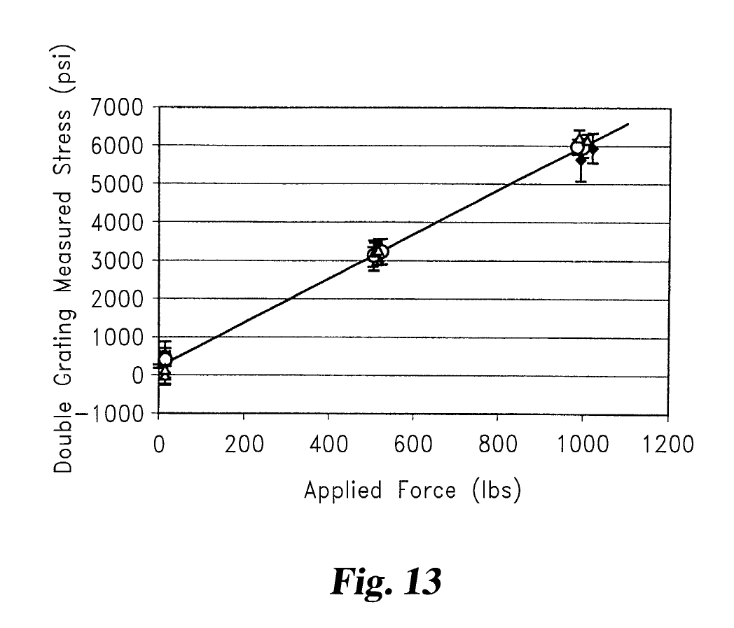

FIG. 13 shows the results of looking for non-uniformities in the stress through the thickness of the sample over a range of applied force using the double thermal grating technique. For these measurements the singly deflected beam was positioned at the center of the thickness of the sample and at ±0.5 mm from the center and the pair of thermal gratings were approximately centered on the middle of the width of the sample. The error bars are the one standard deviation error estimates from the linear least squares fit of the phase retardation versus double grating separation. There is no systematic variation in these measured stresses with position through the thickness. Thus, the through thickness birefringence measurements should give an accurate measurement of the compressive stresses.

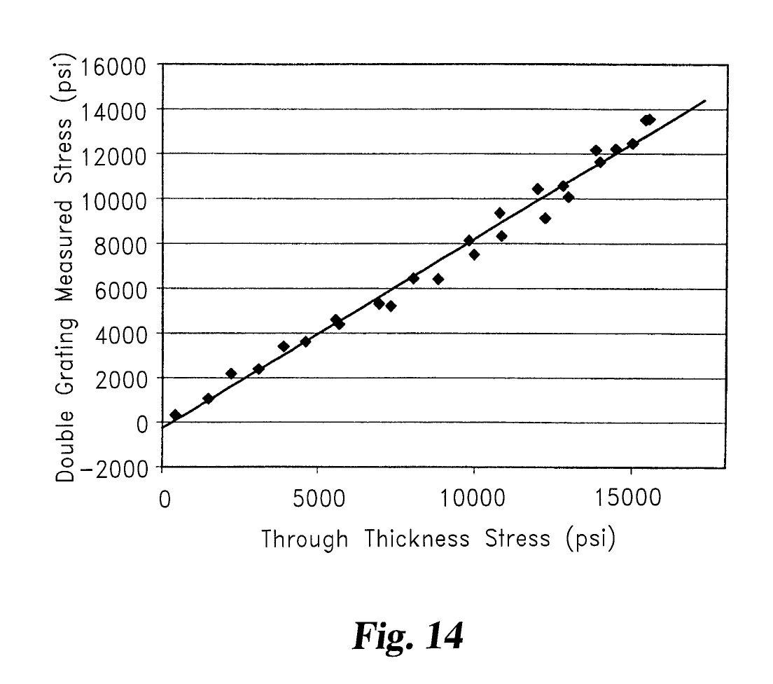

FIG. 14 shows the variation of the stress measured by the double thermal grating technique versus the through thickness stress. The quadratic fit shown in FIG. 12 was used to convert the applied forces measured with the load cell into through thickness stresses. These data show a good linear correlation between the two stress measurement methods. The linear least squares fit of these data gives a slope of 0.85±0.02 where the error estimate is one standard deviation of the fit. There are two obvious reasons why this slope differs from unity. The first is that the two methods were not measuring the stress at exactly the same point in the glass. The second is that the two methods are not measuring exactly the same quantity. The through-thickness measurement measures S_{b}-Sₐ while the double thermal grating technique measures S_{b}-S_{c} where the vertical b-axis is the direction of the compression, the c-axis is normal to the faces of the sample, and the horizontal a-axis is in the plane of the glass. The data in FIG. 13 indicate that S_{c} is near zero, therefore, S_{b}-S_{c} should be very close to S_{b}. In contrast, the non-uniform stress indicated in FIG. 12 would predict that Sₐ would be a tensile stress near the middle of the glass, therefore, the through thickness method, which measures S_{b}-Sₐ, would yield a value larger than S_{b} by the magnitude of the Sₐ. With no force applied, Sₐ is zero in this annealed sample but |Sₐ| to first order increases linearly with the applied force as does S_{b}. Thus to first order S_{b}-Sₐ should be proportional to but larger than S_{b} because the tensile stress, Sₐ is negative. This is consistent with the slope in FIG. 14 that is less than 1.

Tempered Glass Measurement

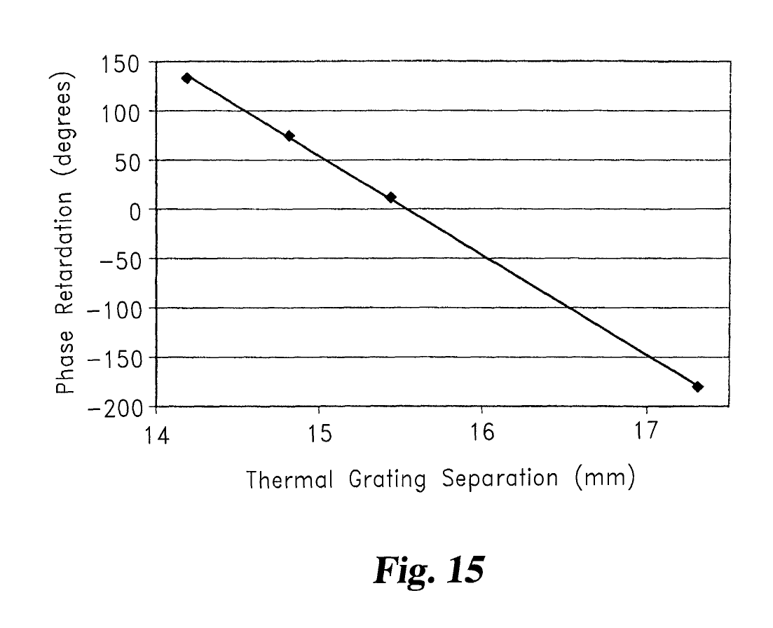

FIG. 15 shows a measurement of the tensile stress in a sample of tempered automotive glass made from Visteon Tint glass that has surface stresses in the range of 15,000 psi to 16,000 psi as measured with a Laser GASP instrument. From the slope of the line that was fit to the four data points, the tensile stress is measured to be 8074±98 psi where the error estimate is the one standard deviation error estimate. This value is in excellent agreement with the expected value of one half of the surface compression that is predicted for a quadratic stress profile through the thickness. The second thermal grating was about 45 mm from the rounded and ground edge of the sample and the laser beams were aligned so that the singly deflected beam struck the middle of the edge of the sample. A more general method of measuring the depth at which the probe beam intersects the first thermal grating is to measure the separation between the two points where the NIR and green beams intersect the surface of the glass sample.

For these data, we used an alternative method to measure the phase retardation of the doubly deflected beam. In this alternative, a piece of polarizing film was slowly rotated to locate the orientation and ellipticity of the polarization. This method has different possible systematic errors than the Stokes meter measurements and it is gratifying to see that this method of measuring the retardation also gives data that are well fit by a straight line.

The absolute accuracy of the stress measurement can be improved not only by increasing the accuracy of obtaining retardation data but also by the removing or reducing the uncertainty in the value of the stress optic coefficient for the particular type of glass being tested and/or removing any other systematic errors. For example, at room temperature the stress optic coefficient of annealed fibers of a soda-lime glass (Corning Code 0080) has been found to be 10% lower that that for unannealed fibers. Incorporating this effect can improve accuracy. In addition, the effects of glass composition, including the amounts of components such as ferric and ferrous ions, on the stress optic coefficient could also be included to achieve higher absolute accuracy in the stress measurement.

However, for many applications the need is not for high accuracy but for better information about the spatial variation of stresses. Accordingly, in one preferred embodiment, the stress measurement techniques disclosed herein need not be adapted to be highly accurate in an absolute sense, but instead are used to determine variations in stress within a single sheet and/or among sheets of the same or similar production runs. These stress variations are then used to determine the quality of the glass. For example, the, stress variations through a predetermined volume of a single sheet or as between similar location in multiple sheets from a similar production run can be compared to predetermined limits to determine the glass quality. Other variations of the measurement technique can include provisions to increase the accuracy of the measurement technique, for example careful calibrations, better estimations for the relevant parameters discussed herein, or modification beam power and diameters discussed herein. With a more accurate technique absolute stress data can be determined and used to assess the quality of the glass.

The variation in the stresses in tempered glass adds two effects that affect the double thermal grating technique. The first is due to the finite size of the singly deflected beam, which was about 0.5 mm in diameter in the presented work. Near the surfaces, the stress, and hence the birefringence, varies rapidly over that distance. This works to depolarize the light in the singly deflected beam and limits how close to the surface this technique will work relative to the beam diameter.

Another effect of the varying stress versus depth in tempered glass is that it creates a gradient in the refractive index that changes the propagation of the singly deflected beam and the vertical and horizontal polarizations see different index gradients. For a uniaxial stress S, the changes in the refractive index, Δn, for the electric field parallel and perpendicular to the direction of stress are

$$Δ {n}_{parallel} = n \frac{S}{E} ( \frac{q}{v} - 2 σ \frac{p}{v} )$$

$$Δ {n}_{perpendicular} = n \frac{S}{E} ( ( - σ ) \frac{q}{v} + ( 1 - σ ) \frac{p}{v} )$$

where E is Young's modulus, σ is Poisson's ratio, and p/v and q/v are the strain optic coefficients that are respectively 0.31 and 0.21 for soda-lime glass. For equal in-plane stresses, the refractive index change seen by light traveling in the plane and polarized either in-plane or out-of-plane, the refractive index changes are

Δnᵢₙ₋ₚₗₐₙₑ=Δnₚₐᵣₐₗₗₑₗ+Δn_{perpendicular}

Δn_{out-of-plane}=2Δn_{perpendicular}

and the difference between these two equations give the strain birefringence.

For example, for a 3.5 mm thick piece of glass with a quadratic stress profile that has a surface stress of 16,000 psi and a 15 mm pathlength that is 0.25 mm from the mid-plane of the glass, the refractive index gradients would cause deflections of 1.7 mrad and 2.9 mrad for the out-of-plane and in-plane polarizations respectively. These values are much larger than the predicted angular acceptance of these thermal gratings. Just like a lens, the deflection increases with the distance from the center. It appears that the wide angular spread in the horizontal plane of the singly deflected beam is beneficial to the performance of the double thermal grating technique in tempered glass. Both of these consequences of the large stress variations with depth make application of this double thermal grating technique most effective in the middle of tempered glass samples.

It has been determined by the present inventors that various relationships and/or characteristics of the writing and probe beams enhance the performance of the systems and techniques described herein. It is contemplated that each of these relationships can be satisfied individually, in combination with any one or more of the other constraints for the writing beams or for the probe beam, or not at all, depending on the particular application of the principles of the present invention. It is also contemplated that these relationships can be accommodated by selecting the initial properties of the beam, such as its diameter and wavelength, and/or by subsequent focusing or other modification to the beam properties.

To most accurately measure the maximum stress at the center of the thickness of thin glass, the writing beam diameters should be less than about 20% of the thickness of the glass. For thicker beam profiles a lower stress value would likely be obtained due to averaging in the lower tensile stresses away from the center. It is expected that for thicker glass, greater than about 1 cm, the stress profiles are flatter in the center and so a relatively wider writing beam could be used. For reasons analogous to those expressed above, the probe beam diameter is preferably smaller than 20% of the thickness of the glass.

To improve the signal to noise ratio, the thickness of the writing beams is preferably less than the distance in which the stress birefringence creates a 180 degree phase shift between the principle polarizations. The polarization change that gives the stress measurement is averaged over a range of path lengths between the two gratings where the range of path lengths increases with the diameters of the writing beams. This range of path lengths is preferably less than, and more preferably substantially less than, the distance in which the stress birefringence creates a 180 degree phase shift between the principle polarizations to avoid the polarization being averaged away. The distance for the 180 degree phase shift can be determined or estimated and is one half the probe wavelength (532 nm) divided by the product of the stress times the stress optic coefficient of the material. As an example, for the tempered automotive glass results reported herein, where the tension in the center is about 8000 psi, this distance is about 1.8 mm. For reasons analogous to those expressed above, the probe beam diameter is preferably smaller than the distance giving a 180 degree phase shift in the principle polarization components.

The writing beams can also be configured to minimize the effect of differing optical path lengths through the glass. Due to the non-zero width of the writing beam, different portions across the diameter of the writing beam can experience different optical path lengths through the glass, causing a proportional degradation to the wavefront profile of the beam. This optical path difference can arise, for example, from the glass not being flat on one or both opposing surfaces over the area of the writing beam or from there being variations in the refractive index of the glass over the area of the writing beam. The optical path difference can also depend on the optical quality of the glass, that is its surface smoothness and the homogeneity of the refractive index of the glass. The writing beam diameter and wavelength should preferably be selected such that the difference in optical path through the glass is less than one-fourth the wavelength of the writing beam. For similar reasons, the probe beam diameter and wavelength is preferably selected to make the difference in optical path through the glass less than one fourth the wavelength of the probe beam.

For increased signal to noise ratio, the probe beam diameter is preferably approximately equal to that of writing beam and more preferably less than about one half the diameter of the writing beam. Any probe beam light that doesn't go through the thermal grating, whose diameter is determined by the diameter of the writing beam, would not ordinarily be deflected, and only the light in the probe beam going through the center of the thermal grating is deflected with maximum efficiency. At constant probe beam power, reduced efficiency decreases signal levels. If the probe beam power is increased to increase the signal then the interfering scattered probe light levels will also increase. The resulting decrease in signal-to-noise ratio will decrease the effectiveness of the technique.

Another effect concerns the acceptable angular tolerance between the various beams and the amount of signal loss attributable to angular variations. The required accuracy in the angle between the writing and probe beams to maintain a constant signal to noise ratio increases linearly with the length of the probe beam that is in the thermal grating. The maximum length of the probe beam in the thermal grating (which gives the maximum deflection efficiency) is determined by the geometry and the diameter of the writing beam. For the orientation depicted in FIG. 2, once the diameter of the writing beam is larger than about 150% of the thickness of the glass, then the probe beam length in the thermal grating reaches a maximum determined by the glass thickness. Thus, for a 1 cm diameter writing beam and 6 mm thick glass, the angle between the beams requires a full width at half maximum angular tolerance of 0.1 mrads, and in order to be within 20% of the maximum efficiency, the angle had to be correct to about 20 μrads. By contrast, for equivalent performance with a writing beam diameter of about 0.5 mm, the angle between these two beams only needs to be aligned to within about 400 micro radians.

Relationships also exist as to a lower range for the size of the beams. As described above, the deflection efficiency scales as the square of the writing beam diameter at constant fluence (pulse energy per area). The total signal is proportional to the square of the deflection efficiency since there are two deflections. Thus the total signal decreases as the fourth power of the beam diameter. Accordingly, the writing beam diameter is preferably selected to be of sufficient size to provide an acceptable signal to noise ratio. For analogous reasons, the probe beam diameter is preferably selected to be of sufficient size to provide an acceptable signal to noise ratio.

In addition, at constant fluence at the center of the beam, going to smaller beam diameters increases the refracting power of the thermal lens created by the writing beam. This refracting power is proportional to one divided by the effective focal length of the thermal lens, and the refracting power increases as one divided by the square of the beam diameter. If the thermal lensing is large enough to bend the wavefronts of the writing beam by more that about one fourth of a wavelength, deflection efficiency can be substantially decreased. Accordingly, the writing beam diameter is preferably selected such that the thermal lensing of the formed thermal grating does not bend the wavefronts of the writing beam by more than about one fourth of a wavelength.

Similarly, smaller probe beam diameters increase thermal lensing that will decrease deflection efficiency if it causes the probe beam wavefronts to bend by more than one fourth the probe beam wavelength. Accordingly, the probe beam is also preferably configured such that any thermal lensing does not bend the wavefronts of the probe beam by more than about one fourth of a wavelength.

As the writing beam diameter in the glass gets smaller, the distance over which the wave fronts of the writing beam are flat enough for efficient deflection decreases. This distance over which the wavefronts are flat enough is proportional to the square of the beam diameter in the glass. The writing beam that is reflected back through the glass should preferably still have flat enough wavefronts in the glass to give a high contrast interference pattern in the glass to form a thermal grating that can have maximum deflection efficiency. In one variation to compensate for the effect of smaller beam diameters, additional optics, such as a curved rather than a flat mirror for reflecting the writing beam back through the glass (see mirror 134 in FIG. 2), can be included to partially correct the reflected wavefronts to give high contrast interference fringes. Substitution of a curved mirror might lead to increased difficulty in obtaining proper optical alignment.

The maximum probe beam peak fluence (pulse energy per unit area at the center of the probe beam) is determined primarily by the damage threshold of the glass, and decreasing the probe beam diameter at constant peak fluence reduces the probe beam pulse energy and hence the signal levels proportional to the square of the diameter.

The probe beam wavefronts are preferably flat across the diameter of the thermal grating. If the probe beam is focused to a very small diameter then the wavefronts might not be flat across the thermal grating and efficiency would be reduced.

Preferably, through the various techniques disclosed here, all beam diameters and configurations are selected to maintain a peak to valley deviation of the wavefront across the diameter of the writing beam of less than one fourth of the wavelength of the probe beam. More preferably this deviation is less than about one tenth of the probe beam wavelength, the wavelength and the deviation being measured in the same medium, for example both in air or both in glass.

While the invention has been described above with respect to glass processing, it is also contemplated that stress measurements can be made on optical plastics or organic polymer glasses as well. Examples of these materials include plexiglass and polycarbonate.

When interrogating glass or these other materials, the wavelength of the writing beam is preferably selected to be partially absorbed by the material, where partially absorbed means that between about 1% and 75% of the light is absorbed in a single pass through the sample. Also, the wavelength of the probe beam is preferably selected to be approximately one-half that of the writing beam wavelength and such that less than 90% of the light is absorbed in traveling about 1 cm through the material. It is believed that a wavelength near 1 micron for the writing beam and near 500 nm for the probe beam will be adequate for most plastics containing hydrogen, such as for example polycarbonate.

In addition, it is to be understood that depending on, for example, the wavelength of light used and the respective index of refraction of the material to be interrogated, the orientation of the light beams may need to be adjusted. At the first thermal grating, the angle in the material between the probe beam and the writing beam and the angle between the surface of the material and the probe beam is given by the vector equation k_single_deflected=k_writing+k_probe (see FIG. 3 and accompanying discussion). Where the magnitude of k_single_deflected is equal to the magnitude of k_probe, which is equal to 2π divided by the wavelength of the probe beam in the material, the magnitude of k_writing is 4π divided by the wavelength of the writing beam in the material. The direction of the vector k_probe is the direction the probe beam travels in the material and the direction of k_single_deflected is the projection of k_probe in a plane parallel to the surface of the material. The direction of the vector k_writing is the direction of the retro-reflected writing beam in the material. The angles of the probe and writing beams outside of the material can be calculated using Snell's law and the directions of the beams in the material. At the second thermal grating, the writing beam is parallel to the writing beam of the first thermal grating and the doubly deflected beam is very close to parallel to the probe beam at the first thermal grating. Unless the material to be interrogated has a refractive index at the probe and writing wavelengths that is much different than the value of 1.5 that is typical of many glasses, then the geometry will be very close to that used in the illustrated embodiment.

It is also understood that while in the illustrated embodiment, the thermal gratings are formed parallel to each other, causing the doubly deflected beam to exit the glass on the opposite side from where the probe beam entered the glass, other configurations are possible. For example, the angle of the writing beam for the second thermal grating from the surface normal can be the negative of that for the first thermal grating. The result of this change would be for the doubly deflected beam to exit the sample on the same side of the sample as the probe beam enters the sample rather than the opposite side as occurs in the illustrated embodiment.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

We claim:

1. A method of detecting properties of a material, comprising:
(a) selecting a first distance;
(b) pulsing a light source to generate a first beam;
(c) forming a second beam from the first beam;
(d) increasing the frequency of the first beam after forming the second beam;
(e) forming a third beam from the second beam;
(f) passing the second and third beams through a piece of the material;
(g) generating first and second thermal gratings in the material with the second and third beams, the first and second thermal grating separated by the selected distance;
(h) polarizing the first beam to a predetermined first polarization;
(i) passing the first polarized beam through a portion of the first thermal grating;
(j) deflecting the beam with the first thermal grating to form a first deflected beam traveling within a portion of the material;
(k) deflecting the first deflected beam with the second thermal grating to form a second deflected beam, the second deflected beam exiting the material;
(l) detecting the polarization state of the second deflected beam.

2. The method of claim 1 further comprising:
(m) selecting a second distance different than the first distance;
(n) repeating actions (b)-(l) with the second selected distance;
(o) determining the stress in the material from the polarization states of the second deflected beams.

3. The method of claim 1 wherein the first deflected beam travels through the material in a direction substantially parallel to a surface of the material adjacent the first deflected beam.

4. The method of claim 3 wherein the first deflected beam travels at a distance about midway between opposing surfaces of the material before encountering the second thermal grating.

5. The method of claim 4 wherein the first distance is greater than the thickness of the material at the location the first polarized beam first encounters a surface of the material.

6. The method of claim 1 further comprising focusing the second and third beams such that they strike the material with a beam width less than about 0.5 mm.

7. The method of claim 1 wherein the polarization state of the second deflected beam is detected with a detector assembly including a detector and a moveable mirror that directs the second deflected beam towards the detector, the method further comprising translating the mirror and deflecting the second deflected beam after the translating.

8. The method of claim 1 wherein the optical path length of the first beam is greater than the optical path length of the second beam, the optical path lengths being measured to their respective intersection with the piece of material.

9. The method of claim 8 wherein the first beam reaches the material at least about 2 ns after the second beam reaches the material.

10. The method of claim 1 wherein the first polarized beam has a width selected to maintain a peak to valley deviation of the wavefronts of the first polarized beam to be less than about one fourth of the wavelength of the first polarized beam through the intersection of the first polarized beam with the first thermal grating.

11. The method of claim 10 further comprising focusing the first beam to have a width less than about ½ the width of the beam forming the first thermal grating while passing through a portion of the first thermal grating.

12. The method of claim 1 wherein the first beam has a width less than about 20% of the thickness of the material while passing through a portion of the first thermal grating.

13. The method of claim 1 wherein the second and third beams have a width at a material surface less than the distance in which the stress birefringence in the material at the distance from the surface of the 1^{st} deflected beam creates a 180 degree phase shift between the principle polarizations of the first deflected beam.

14. The method of claim 1 wherein for each of the second and third beams the difference in optical path length through the material across the width of the beam is less than about one fourth the wavelength of the beam in the material.

15. The method of claim 1 wherein the width of the second and third beams at a material surface is selected such that self-focusing does not bend the wavefronts of the second and third beams more than about one fourth of the wavelengths of the respective beams.

16. A method for analyzing material comprising:
delivering a first beam to form a first thermal grating in a piece of the material,
delivering a second beam to form a second thermal grating in the material,
delivering a polarized probe beam to the material at least about 2 ns after delivering the first beam to the material,
deflecting the probe beam with the first thermal grating to form a first deflected probe beam,
deflecting the first deflected probe beam with the second thermal grating to form a second deflected probe beam, the second deflected probe beam exiting the material,
determining the polarization state of the second deflected probe beam,
determining the quality of the material from the polarization state of the second deflected probe beam.

17. The method of claim 16 wherein:
the first and second beams are formed from a single source.

18. The method of claim 16 wherein:
the probe beam and at least one of the first and second beams are formed from a single source.

19. The method of claim 16 wherein:
the probe beam has a wavelength about ½ the wavelength of at least one of the first and second beams.

20. The method of claim 18 wherein:
the single source comprises a pulsed laser.

21. The method of claim 20 wherein:
the probe beam has a wavelength about ½ the wavelength of at least one of the first and second beams and is formed by increasing the frequency of a laser pulse after splitting a beam from the laser pulse to form at least one of the first and second beams.

22. The method of claim 16 wherein determining the quality of the material includes:
varying the separation between the first and second thermal gratings,
determining the polarization change of the second deflected probe beam as a function of the variation of the separation between the first and second thermal gratings.

23. The method of claim 22 further comprising:
determining the stress in the material from the determined polarization change,
determining the quality of the material from the determined stress in the material.

24. The method of claim 22 further comprising:
forming the second beam by directing a portion of the first beam to a moveable mirror,
varying the separation between the first and second thermal gratings by translating the moveable mirror.

25. The method of claim 22 further comprising:
detecting the polarization state of the second deflected probe beam by deflecting the second deflected probe beam to a detector with a moveable mirror,
translating the mirror to direct the second deflected beam to the detector and compensate for variations in the separation between the thermal gratings.

26. The method of claim 16 wherein the material is processed with a system including a controller and a quenching station prior to delivering the probe beam, the controller controlling at least one process parameter,
the method further comprising modifying a controlled process parameter in response to the determined quality of the material falling outside prescribed limits.

27. The method of claim 26 wherein the controller controls a quenching parameter, the method further comprising modifying a quenching parameter in response to the determined quality of the material falling outside prescribed limits.

28. The method of claim 16 further comprising:
sensing the temperature profile through the thickness of the material while processing the material to control the quality of the material,
determining the quality of the material from the polarization state of the probe beam and the second deflected probe beam after processing the material to validate the controlled quality.

29. The method of claim 16 wherein the polarized probe beam has a width selected to maintain a peak to valley deviation of the wavefront across the width of the beam forming the first thermal grating of less than about one fourth of the wavelength of the first polarized beam.

30. The method of claim 29 further comprising focusing the probe beam to have a width less than about ½ the width of the beam forming the first thermal grating while passing through a portion of the first thermal grating.

31. The method of claim 16 wherein the probe beam has a width less than about 20% of the thickness of the material while passing through a portion of the first thermal grating.

32. The method of claim 16 wherein the first and second beams have a width at a material surface less than the distance in which the stress birefringence in the material at the distance from the surface of the first deflected beam creates a 180 degree phase shift between the principle polarizations of the first deflected probe beam.

33. The method of claim 16 wherein the difference in optical pathlength across the width of the beams is less than about one fourth the wavelength of the beam through the material for each of the first and second beams.

34. The method of claim 16 further comprising delivering the first and second beams to a material surface such that self-focusing does not bend the wavefronts of those beams more than about one fourth of the wavelengths of the respective beams.

35. A method of determining the quality of glass comprising:
forming a first thermal grating in the glass,
forming a second thermal grating the in the glass separated from the first thermal grating,
delivering a probe beam into the glass at a first location in the glass after forming the first thermal grating, the probe beam having a width less than about 0.2 times the thickness of the glass at the first location,
detecting a doubly deflected probe beam after deflecting at least a portion of the probe beam with the first and second thermal gratings,
determining the quality of glass from the detected doubly deflected probe beam.

36. The method of claim 35 further comprising
varying the separation between the first and second thermal gratings,
detecting the doubly deflected probe beam at varying separations of the first and second thermal gratings.

37. The method of claim 36 further comprising:
comparing the variation of the polarization of the doubly deflected probe beam with the variation in the separation between the first and second thermal gratings.

38. The method of claim 37 further comprising:
determining the stress in the glass between the first and second the thermal grating from the comparison.

39. The method of claim 35 wherein the probe beam has a peak to valley deviation of the wavefront across the width of the beam at the first location less than about one fourth of the wavelength of the first probe beam.

40. The method of claim 35 further comprising:
delivering a beam to form the first thermal grating.

41. The method of claim 40 further comprising:
focusing the probe beam to have a width less than about ½ the width of the beam forming the first thermal grating while passing through a portion of the first thermal grating.

42. The method of claim 40 wherein the beam forming the first thermal grating has a width in the glass less than the distance in which the stress birefringence in the glass along the optical path of the probe beam between the first and second deflections thereof creates a 180 degree phase shift between the principle polarizations of the probe beam.

43. The method of claim 40 wherein the difference in optical pathlength for the beam forming the first thermal grating through the glass across the width of the beam is less than about one fourth the wavelengths of the beam.

44. The method of claim 35 further comprising delivering the first and second beams to a glass surface such that self-focusing does not bend the wavefronts of the second and third beams more than about one fourth of the wavelengths of the respective beams.

45. A method of determining stress in transparent materials comprising:
generating a probe beam,
generating a first writing beam,
generating a second writing beam,
forming first and second thermal gratings with the first and second writing beams,
focusing the probe beam on the first thermal grating such that the width of the probe beam is less than about half the width of the first beam forming the first thermal grating,
deflecting the probe beam with the first and second thermal gratings,
detecting the probe beam after the deflections.

46. The method of claim 45 further comprising:
determining the polarization of the detected probe beam, and
determining the stress in the material from the determined polarization.

47. The method of claim 45 further comprising:
delivering the first writing beam to the material to form the first thermal grating, and
delivering the probe beam to the first thermal grating at least about 2 ns after delivering the first writing beam to the material.

48. The method of claim 45 further comprising:
focusing the first and second writing beams onto the material to form the first and second thermal gratings.

49. The method of claim 48 wherein
the first and second writing beams have a width in the material,
wherein the width is less than the distance in which the stress birefringence in the material along the optical path of the probe beam between deflections by the first and second thermal gratings creates a 180 degree phase shift between the principle polarizations of the probe beam.

50. A system for sensing properties of transparent materials comprising:
a source of a probe beam,
at least one source of first and second writing beams, the writing beams being directed through the material,
a motorized translation stage coupled to at least one first mirror for directing the second writing beam to a plurality of locations in the material, the plurality of locations being at varying distances from the first writing beam in the material,
at least one retroreflective mirror adapted to reflect the writing beams back through the material to create a pair of standing waves in the material, the standing waves forming first and second thermal gratings in the material,
wherein the probe beam is directed to intersect the first thermal grating in the material such that at least a portion of the probe beam is deflected by the first thermal grating and travels towards the second thermal gratings where it is deflected a second time to form a doubly deflected beam that exits the material, and
a detector assembly including a detector and a motorized translation stage coupled to at least one second mirror, the motorized translation stage translating the mirror to direct the second deflected beam towards the detector and to accommodate variations in the location of the doubly deflected beam due to the second thermal grating being formed at the plurality of locations.

51. The system of claim 50 further comprising:
at least one computer coupled to the first and second motorized translation stages and to the detector, the computer correlating the signal received at the detector with positions of the translation stages to determine a property of the material.

52. The system of claim 50 further comprising:
a pair of position sensitive detectors for monitoring the relative orientation of the probe and at least one of the writing beams.

53. The system of claim 52 wherein the pair of position sensitive detectors are positioned to view reflections of the probe beam and at least one of the writing beams.

54. The system of claim 52 further comprising a camera for monitoring the locations where the probe and at least one of the writing beams intersect the material.

55. The system of claim 54 further comprising:
at least one computer coupled to the first and second motorized translation stages and to the detector, the computer correlating the signal received at the detector with positions of the translation stages to determine a property of the material, and
wherein the pair of position sensitive detectors are positioned to view reflections of the probe beam and at least one of the writing beams, and
wherein the positions sensitive detectors are coupled to the at least one computer, the computer monitoring the relative orientation of the probe and writing beams.

56. The system of claim 50 further comprising:
a beam splitter for splitting the probe and writing beams from a common beam, and
a frequency doubling crystal for increasing the frequency of the probe beam after splitting the writing beams from the common beam.

57. A system for evaluating characteristics of a transparent material comprising:
an optical assembly for delivering a probe beam and a pair of writing beams to a surface of the material,
wherein the writing beams are retroreflected through the material to form first and second thermal gratings in the material,
wherein the probe beam intersects the first thermal grating causing at least a portion thereof to travel substantially parallel to a surface of the material and intersect the second thermal grating to form a doubly deflected beam that exits the material,
a detector assembly for receiving the doubly deflected beam and determining the polarization state of the doubly deflected beam,
wherein the optical assembly includes means for forming the second thermal grating at varying distances from the first thermal grating,
wherein the detector assembly includes means for capturing the doubly deflected beam formed at the second thermal grating at varying distances from the first thermal grating.

58. The system of claim 57 wherein the means for forming includes a beam splitter and a translatable mirror,
wherein the beam splitter directs a portion of a beam to the translatable mirror, and
wherein the mirror translates to direct a writing beam to varying location in the matmerial.

59. The system of claim 57 wherein the means for capturing includes a translatable mirror for directing the doubly deflected beam to an optical detector forming a portion of the detector assembly.

60. The system of claim 57 further comprising:
at least one position sensitive light detector for monitoring the alignment of at least one of the probe and writing beams.

61. The system of claim 60 wherein the position sensitive light detector monitors a reflection of the at least one probe and writing beams from a surface of the material.

62. The system of claim 60 comprising first and second position sensitive light detectors monitoring the alignment of the probe beam and at least one of the writing beams respectively.

63. The system of claim 62 further comprising means for adjusting the orientation of the probe beam to maintaining the alignment between the probe and at least one writing beam.

64. The system of claim 57 wherein the optical assembly includes focusing optics to focus the writing beams to have a beam width less than about 0.5 mm when they first intersect a surface of the material.

65. The system of claim 64 wherein the optical assembly includes focusing optics to focus the probe beam to intersect the writing beam in the material wherein the probe beam has a width less than about 0.5 times the writing beam width during the intersection.

66. The system of claim 57 wherein the probe and writing beams are formed from a single source and wherein the optical pathlength from the single source to the first surface of the material for the probe beam is substantially longer than the optical pathlength of at least one of the writing beams from the single source to the first surface of the material so as to form a delay between the arrival of the writing beam and the probe beam to the first surface.

67. The system of claim 66 wherein the delay is at least about 1 nanosecond.

68. The method of claim 1 wherein the material is glass.

69. The method of claim 16 wherein the material is glass.

70. The method of claim 35 wherein the material is glass.

71. The method of claim 45 wherein the material is glass.

72. The method of claim 1 wherein the maximum pulse energy per area in the second and third beams at a material surface is selected such that the optical path length through the material for each beam does not change by more than one half of the wavelength of the respective beam between the beginning and end of the pulse.

73. The method of claim 20 wherein the maximum pulse energy per area in the second and third beams at a material surface is selected such that the optical path length through the material for each beam does not change by more than one half of the wavelength of the respective beam between the beginning and end of the pulse.
